(19) United States
(12) Patent Application Publication
(10) Pub. No.: US 2025/0324426 A1
(43) Pub. Date: Oct. 16, 2025

(54) FAST UPLINK (UL) ACCESS ON LTM CANDIDATE CELL

(71) Applicant: TELEFONAKTIEBOLAGET LM ERICSSON (PUBL), Stockholm (SE)

(72) Inventors: Venkatarao Gonuguntla, Sundbyberg (SE); Claes Tidestav, BÅLSTA (SE); Icaro Leonardo Da Silva, SOLNA (SE); Antonino Orsino, KIRKKONUMMI (FI); Maomao Chen Larsson, LUND (SE)

(21) Appl. No.: 19/250,861

(22) Filed: Jun. 26, 2025

Related U.S. Application Data
(63) Continuation of application No. PCT/EP2024/059189, filed on Apr. 4, 2024.

(51) Int. Cl. H04W 72/21; H04W 74/00; H04W 74/0833

(52) U.S. Cl. CPC H04W 72/21; H04W 74/006; H04W 74/0833

(57) ABSTRACT

A method performed by a user equipment for Uplink access on a L1/L2 triggered inter-cell mobility, LTM, candidate cell. The method includes receiving, from a network node, an LTM configuration for at least one LTM candidate cell, receiving a trigger from the network node, and receiving a first synchronization signal from the LTM candidate cell. The method further includes, in response to receiving the trigger, transmitting a UL signal to the LTM candidate cell during a UL resource occasion, where the UL resource occasion occurs during a period of time that is between receiving the trigger and receiving the first synchronization signal from the LTM candidate cell. The first synchronization signal is received after the trigger is received. Related network node methods, UEs and network nodes are also disclosed.

### RELATED APPLICATIONS

The present application is a continuation of International Application No. PCT/EP2024/059189, filed Apr. 4, 2024, which claims priority to U.S. Provisional Patent Application No. 63/456,892, filed Apr. 4, 2023, entitled “FAST UPLINK (UL) ACCESS ON LTM CANDIDATE CELL,” the disclosures of which are hereby incorporated herein by reference in their entirety.

### TECHNICAL FIELD

The present disclosure relates to wireless communication systems, and in particular, to establishment of timing alignment in wireless communication systems.

### BACKGROUND

Different user equipment (UE) devices in the same cell are typically located at different positions within the cell and at different distances to the base station (e.g., NR gNodeB). The transmissions from the different UEs may suffer from different delays until the transmissions reach the base station. To ensure that the Uplink (UL) transmissions from a UE reaches the base station within the corresponding receive window for the base station, an uplink timing control procedure is typically used. This control procedure avoids intracell interference from occurring, both between UEs assigned to transmit in consecutive subframes and between UEs transmitting on adjacent subcarriers.

Time alignment (TA) of the uplink transmissions may be achieved by applying a timing advance value at the UE transmitter, relative to the received downlink timing. The main role of this is to counteract differing propagation delays between different UEs, as shown in FIG. 1 and described below for an LTE eNodeB.

Notably, FIG. 1 illustrates a time alignment of uplink transmissions for a case (a) without timing advance and for a case (b) with timing advance. To achieve the time alignment, to obtain UL synchronization, the base station (e.g., gNodeB, eNodeB) derives a Timing Advance value that the UE needs to use for the UL transmissions in order to reach the base station within the receive window and indicates this to the UE. When the UE accesses a cell, it uses the random-access procedure where the received Msg1 (the PRACH preamble) is used by the base station to determine the UE's initial TA to use for UL transmissions in the cell. During the connection, the base station then continuously monitors whether the UE needs to advance and/or delay the UL transmissions, to compensate for changes in propagation delay, and indicates to the UE if there is a need to change the timing advance value.

Time Alignment in L3 Mobility (Handover/Reconfiguration with Sync)

In legacy L3 mobility in 5G New Radio (NR), also called a reconfiguration with sync for the Master Cell Group (MCG), when the UE changes its Primary Cell (PCell), the UE always performs random access with the target PCell. As part of that, the UE transmits a PRACH preamble in the UL, which enables the target gNodeB to calculate the timing advance value for the UE, which is provided in the Random-Access Response (RAR) so that from Msg3 onwards the UE is able to transmit UL messages on PUCCH and/or PUSCH.

### PRACH Transmissions

In NR, diverse implementation of the cells is possible. For example, some cells (e.g., FR1 cells) may be implemented to provide large coverage and some cells (e.g., FR2 cells) may be implemented to provide more throughput over a short coverage area. The maximum distance between the base station and the UE in a cell depends on the cell coverage area. Due to diverse implementations, the same set of PRACH preambles may not work well in all the scenarios. To solve this, different preamble formats with different lengths of PRACH preambles are introduced in NR.

The RACH transmission occasion, or RACH occasion, depends on the type of RACH. RACH occasion is an area specified in the time and frequency domains that is available or reserved for the transmission of the RACH preamble by the UE. In NR, two types of RACH are supported, namely contention-based RACH and contention free RACH.

For contention-based RACH, the RACH occasion is computed at the UE based on the configuration from the network and the certain conditions observed at the UE.

In NR, each beam is associated with a different synchronization signal (e.g. a SSB) and is transmitted in a spatial direction. Each SSB is configured with certain preamble indexes and certain RACH transmission occasions. Based on an SSB seen by the UE, the UE determines the preamble index to be transmitted and the RACH occasion during which the preamble is to be transmitted. The network can determine which beam UE has been selected, as the network can configure the mapping between SSB and RACH Occasion (RO). By detecting which RO the UE sends PRACH to, the network can determine which SSB Beam that UE has selected.

The mapping between SSB and RACH Occasion is defined by the following two RRC parameters: i) msg1-FDM (it is configured in RACH-ConfigGeneric and can be found in TS 38.331 v17.1.0) and ii) ssb-perRACH-OccasionAndCB-PreamblesPerSSB (it is configured in RACH-ConfigCommon it can be found in 38.331 v17.1.0).

Contention free RACH is scheduled by the network and the scheduling information contains what to transmit and where to transmit. This information is conveyed to the UE by a combination of RRC message and PDCCH (e.g., through Downlink Control Information (DCI) message) order.

RRC messages which carry the CFRA related information are RACH-ConfigDedicated and same can be found in TS 38.331-v17.1.0.

### L1/L2 Inter-Cell Mobility or L1/L2 Triggered Inter-Cell Mobility (LTM) in Rel-18

In Release 18, 3GPP has agreed on a Work Item on Further New Radio (NR) mobility enhancements, in particular, in a technical area entitled L1/L2 based inter-cell mobility. See the WI description (WID in RP-213565 (https://www.3gpp.org/ftp/TSG_RAN/TSG_RAN/TSGR_94e/Docs//RP-213565.zip) for further details.

According to the WID, when the UE moves from the coverage area of one cell to another cell, at some point a serving cell change needs to be performed. Currently, a serving cell change is triggered by L3 measurements and is done by RRC signaling triggered Reconfiguration with Synchronization for a change of PCell and PSCell, as well as release add for SCells when applicable. All cases involve complete L2 (and L1) resets, leading to longer latency, larger overhead, and longer interruption time than beam switch mobility. The goal of L1/L2 mobility enhancements is to enable a serving cell change via L1/L2 signaling, in order to reduce the latency, signaling overhead and interruption time.

As part of L1-L2 inter-cell mobility measurement framework, it was agreed to support at least L1-RSRP as the reporting quantity. That means UE is required to report L1-RSRP of the candidate cells to the network so that the network can use them for LTM handover (HO) decisions.

In Release 17, as part of inter-cell beam management, a solution has been standardized where L1-RSRP is measured and reported on a CSI resource that is not associated to a PCI of the serving cells.

L3 HO Procedure Vs. LTM HO Procedure from Total Delay Perspective (See L3 HO Delay Requirements TS 38.331)

### 6.1.1.2.1 Handover Delay

When the UE receives an RRC message implying handover, the UE shall be ready to start the transmission of the new uplink PRACH channel within D_{handover} msec from the end of the last TTI containing the RRC command.

Where:
D_{handover} equals the applicable RRC procedure delay defined in clause 12 in TS 38.331 [2] plus the interruption time stated in clause 6.1.1.2.2

### 6.1.1.2.2 Interruption Time

The interruption time is the time between end of the last TTI containing the RRC command on the old PDSCH and the time the UE starts transmission of the new PRACH, excluding the RRC procedure delay.

When intra-frequency or inter-frequency handover is commanded, the interruption time shall be less than Tᵢₙₜₑᵣᵣᵤₚₜ

$${T}_{interrupt} = {T}_{search} + {T}_{IU} + {T}_{processing} + {T}_{Δ} + {T}_{margin} ms$$

Where:
T_{search} is the time required to search the target cell when the target cell is not already known when the handover command is received by the UE. If the target cell is known, then T_{search}=0 ms. If the target cell is an unknown intra-frequency cell and the target cell Es/Iot≥−2 dB, then T_{search}=Tᵣₛ ms. If the target cell is an unknown inter-frequency cell and the target cell Es/Iot≥−2 dB, then T_{search}=3*Tᵣₛ ms. Regardless of whether DRX is in use by the UE, T_{search} shall still be based on non-DRX target cell search times.
T_{Δ} is time for fine time tracking and acquiring full timing information of the target cell. T_{Δ}=Tᵣₛ for both known and unknown target cell.
T_{processing} is time for UE processing. T_{processing} can be up to 20 ms.
T_{margin} is time for SSB post-processing. T_{margin} can be up to 2 ms.
T_{IU} is the interruption uncertainty in acquiring the first available PRACH occasion in the new cell. T_{IU} can be up to the summation of SSB to PRACH occasion association period and 10 ms. SSB to PRACH occasion associated period is defined in the table 8.1-1 of TS 38.213 [3].
Tᵣₛ is the SMTC periodicity of the target NR cell if the UE has been provided with an SMTC configuration for the target cell in the handover command, otherwise Tᵣₛ is the SMTC configured in the measObjectNR having the same SSB frequency and subcarrier spacing. If the measObjectNRs having the same SSB frequency and subcarrier spacing configured by MN and SN have different SMTC, Tᵣₛ is the periodicity of one of the SMTC which is up to UE implementation. If the UE is not provided SMTC configuration or measurement object on this frequency, the requirement in this clause is applied with Tᵣₛ=5 ms assuming the SSB transmission periodicity is 5 ms. There is no requirement if the SSB transmission periodicity is not 5 ms. If the UE has been provided with higher layer in TS 38.331 [2] signaling of smtc2 prior to the handover command, Tᵣₛ follows smtc1 or smtc2 according to the physical cell ID of the target cell.

In the interruption requirement a cell is known if it has been meeting the relevant cell identification requirement during the last 5 seconds otherwise it is unknown. Relevant cell identification requirements are described in Clause 9.2.5 for intra-frequency handover and Clause 9.3.4 for inter-frequency handover.

As per the above requirements shown, L3 HO delay (D_{handover}) equals the RRC processing delay of the HO command and the interruption time. Where the interruption delay comprises of the following components:
SW and HW processing
Cell search
Acquisition of fine timing
Delay uncertainty of obtaining PRACH preamble

As per the initial discussions of Rel-18 LTM, two potential approaches and two potential timelines are discussed. These are shown in FIGS. 2 and 3. Notably, FIG. 2 illustrates a RAN2 agreed baseline timeline for L1/L2 inter-cell mobility and FIG. 3 depicts an exemplary LTM configuration and an example of an LTM cell switch procedure in which the UE accesses the LTM candidate cell in LTM cell switch in a Random Access procedure.

In LTM, an LTM cell switch procedure has been agreed, in which the UE receives an LTM cell switch command (e.g., a MAC CE including an indication of one of the configured LTM candidate cells) and accesses the indicated LTM candidate cell. In one option, 3GPP assumes that the UE accesses the LTM candidate cell in response to the LTM cell switch command that relies on a Random Access procedure, i.e., when the UE receives the LTM cell switch command from a serving cell (e.g., PCell), the UE transmits a PRACH preamble to the LTM candidate cell and receives a Random Access Response. When the UE receives the LTM cell switch command, one of the steps the UE needs to perform which increases the delay to access the LTM candidate is the DL synchronization in which the UE needs to perform fine time tracking and acquire full timing information of the LTM candidate cell, which is the target cell.

Referring to FIG. 3, to further reduce the interruption time, it has also been agreed that the UE may be configured to establish the Time Alignment with one or more LTM candidate cells before the triggering of the LTM cell switch, so that at the moment of the LTM cell switch the UE would not be required to trigger a Random Access procedure, and instead, the first UE action at the LTM candidate cell which becomes the target cell (i.e., the new PCell) is to monitor PDCCH and/or transmit a UL signal on PUCCH and/or PUSCH, which requires UL sync to be established.

Different options for this Time Alignment (TA) procedure (for UL sync establishment) are still under discussion in 3GPP, but they all rely on the UE, while still connected to the PCell, receiving a trigger (e.g., PDCCH order) from the PCell for transmitting a UL signal (e.g., PRACH preamble) to an LTM candidate cell, so that the Candidate DU at the network side (responsible for the LTM candidate cell) which receives the preamble, calculates a Timing Advance value to be provided to the UE at some point in time, e.g., at the LTM cell switch command, or in a DL response (e.g., via PCell or via the LTM candidate cell). That timing advance value is a value for the UE and the LTM candidate cell in which the UE transmits the PRACH preamble. The TA establishment procedure may be triggered for one or multiple LTM candidate cells. For example, FIG. 4 illustrates at least one example of how this procedure may look like. Specifically, FIG. 4 depicts an example of a TA establishment procedure, in which the UE establishes TA by transmitting a PRACH preamble, and receives the timing advance value in the LTM cell switch command.

There currently exist certain challenge(s). One challenge with the Time Alignment (TA) establishment procedure is that before the UE transmits the PRACH preamble to the LTM candidate cell the UE needs to first perform a DL synchronization, e.g., by detecting and receiving one or more SSB(s) of that LTM candidate cell, so the UE is able to determine PRACH occasion(s) and transmit the PRACH preamble upon reception of the TA establishment trigger, e.g., a PDCCH order.

This could possibly be avoided if the TA establishment procedure is triggered quite early, possibly far in time to the timing to trigger an LTM cell switch. However, a typical network implementation would only trigger the TA establishment procedure when there is some level of more certainty that a certain LTM candidate is a high potential candidate, which may be known at the network (e.g., the S-DU) by the reception of further L1 and/or L3 measurements on the LTM candidate cell. However, doing that would in principle require the procedure for TA establishment to be as fast as possible, so that the timing between TA establishment and LTM cell switch is not too close in time. Another potential issue with the longer delay to transmit the PRACH preamble for TA establishment is that it may not always be possible for the UE to try to sync with an SSB of an LTM candidate and receive/transmit data at the same time from the serving cell(s), which may impact the throughput/data rates.

As PRACH occasions and SSB(s) may be sparse (e.g., 10s of milliseconds) the procedure may not be that fast, and the longer it takes, the closer the UE is to the timing to perform the LTM cell switch, which may also increase the chances of a failure procedure, e.g., as during TA establishment the radio conditions of the serving cell becomes much worse and/or the radio conditions on the LTM candidate becomes much better. FIG. 5 illustrates an example of typical UE actions in this type of scenario. Notably, FIG. 5 illustrates the delay for TA establishment with an LTM candidate cell.

Another potential issue in LTM, in particular when it comes to the TA establishment with one or more LTM candidate cells, is that the UE may be configured with multiple LTM candidate cells as the potential target cells. Based on the measurement reports from the UE, the network may configure the UE to be handed over to one of the candidate cells. Though the UE could measure multiple cells, the UE may not be able to maintain the DL synchronization with all the candidate cells as it may result in higher UE complexity and cost.

Another challenge is with the LTM cell switch procedure, which may also rely on a Random Access procedure as shown in FIG. 6. Before the UE transmits the PRACH preamble to the LTM candidate cell, in response to the LTM cell switch command (e.g., a MAC CE indicating at least the LTM candidate cell), the UE needs to first perform a DL synchronization to one or more SSB(s) of that LTM candidate cell, so the UE is able to transmit the PRACH preamble. That may take some time depending on various factors, such as the SSB periodicity (so that a next possible SSB takes longer to be received), or frequency range (e.g., FR2, mmWave frequencies), in which the UE would require more SSBs in a burst to be received for performing a beam sweeping, which also takes longer. In other words, DL synchronization upon a LTM cell switch increases the LTM cells switch delay and consequently the mobility interruption time, which is being optimized in the whole study item in Rel-18. PRACH occasions and SSB(s) may be sparse (e.g., 10s of milliseconds) and/or the procedure may be too slow.

FIG. 7 illustrates a signaling diagram depicting the problem to be solved for an LTM cell switch without random access.

Another potential issue in LTM cell switch is that the UE may be configured with multiple LTM candidate cells as the potential target cells. Based on the measurement reports from the UE, the network may configure the UE to be switched to one of the candidate cells, or to perform TA establishment. Though UE could measure multiple cells, UE may not be able to maintain the DL synchronization with all the candidate cells as it may result in higher UE complexity and cost.

### SUMMARY

Certain aspects of the disclosure and their embodiments may provide solutions to these or other challenges. The disclosed subject matter describes how a UE reduces the delay in a Time Alignment (TA) establishment/update procedure with an LTM candidate cell and/or in an LTM cell switch procedure.

Some embodiments provide a method performed by a user equipment for Uplink access on a L1/L2 triggered inter-cell mobility, LTM, candidate cell. The method includes receiving, from a network node, a LTM configuration for at least one LTM candidate cell, receiving a trigger from the network node and receiving a first synchronization signal from the LTM candidate cell. The method further includes, in response to receiving the trigger, transmitting a UL signal to the LTM candidate cell during a UL resource occasion, where the UL resource occasion occurs during a period of time that is between receiving the trigger and receiving the first synchronization signal from the LTM candidate cell. The first synchronization signal is received after the trigger is received.

Some embodiments provide a method performed by a network node for a user equipment, UE, access on a L1/L2 triggered inter-cell mobility, (LTM,) candidate cell. The method includes transmitting, from a network node to the UE, an LTM configuration for at least one LTM candidate cell and transmitting a trigger to the UE from the network node.

Some embodiments provide a user equipment for Uplink (UL) access on a L1/L2 triggered inter-cell mobility, LTM, candidate cell, including a processing circuitry configured to perform any of the steps of any of the methods performed by the UE and a power supply circuitry configured to supply power to the processing circuitry.

Some embodiments provide a network node for Uplink (UL) access on a L1/L2 triggered inter-cell mobility, LTM, candidate cell, the network node including a processing circuitry configured to perform any of the steps of any of the methods performed by the network node and a power supply circuitry configured to supply power to the processing circuitry.

One reason to transmit the UL signal between the reception of the trigger and a first synchronization signal (e.g., SSB) of the LTM candidate cell occurring after the trigger, i.e., before the next synchronization signal (e.g., before the next SSB), is that it would not be necessary in this case where the UE is DL synchronized with the LTM candidate cell, so that the UE can transmit in the next available PRACH occasion or assigned/configured PUCCH/PUSCH resource(s) of the LTM candidate cell after the UE receives the trigger from the serving cell. Another possibility is to transmit the UL signal to the LTM candidate cell after the reception of the trigger, and before the next SSB that occurs after the reception of the trigger. One benefit is that the UE does not need to receive an SSB of the LTM candidate cell before transmitting the UL signal to the LTM candidate cell.

According to some embodiments, the trigger may correspond to one or more of:
A trigger for a TA establishment/update procedure, wherein the trigger is received from a serving cell (e.g., a PDCCH order from the Primary Cell, or Primary SCG cell) to transmit a UL signal (e.g., PRACH preamble) for TA establishment/update;
A trigger for an LTM cell switch procedure, wherein the trigger corresponds to an LTM cell switch command (indicating an LTM candidate cell, e.g., LTM configuration ID) from a serving cell (e.g., a MAC CE from the Primary Cell, or Primary SCG cell) to access the LTM candidate.

According to some embodiments, the UL signal may correspond to one or more of:
A PRACH preamble transmitted to a PRACH occasion of the LTM candidate cell in an LTM cell switch;
A PRACH preamble transmitted to a PRACH occasion of the LTM candidate cell in a TA establishment/update procedure;
A Sounding Reference Signal (SRS) transmitted to the LTM candidate cell in an TA establishment/update procedure;
A control information (e.g., scheduling request) transmitted on a Physical Uplink Control Channel (PUCCH) of the LTM candidate cell in an LTM cell switch procedure; and/or
UL data (e.g., including as payload a RRC Reconfiguration Complete) transmitted on a Physical Uplink Shared Channel (PUSCH) of the LTM candidate cell in an LTM cell switch procedure.

According to some embodiments the UL resource occasion may correspond to one or more of:
A PRACH occasion of the LTM candidate cell;
A Sounding Reference Signal resource or resource occasion of the LTM candidate cell which has been configured (e.g., in the RRC configuration of the LTM candidate cell) and/or assigned (e.g., in the LTM cell switch command);
A Physical Uplink Control Channel (PUCCH) resource or resource occasion of the LTM candidate cell which has been configured (e.g., in the RRC configuration of the LTM candidate cell) and/or assigned (e.g., in the LTM cell switch command); and/or
A Physical Uplink Shared Channel (PUSCH) resource or resource occasion of the LTM candidate cell which has been configured (e.g., in the RRC configuration of the LTM candidate cell) and/or assigned (e.g., in the LTM cell switch command).

FIG. 8 illustrates some embodiments where the UE performs a TA establishment/update procedure. Similarly, FIG. 9 depicts an example of when the disclosed subject matter is used for an LTM cell switch procedure relying on random access. FIG. 10 illustrates an example when the disclosed subject matter is used for an LTM cell switch procedure not relying on PUCCH and/or PUSCH transmissions on LTM cell switching.

According to some embodiments, the UE is configured with multiple LTM candidate cell(s) (i.e., more than one candidate cell) and selects a subset of the LTM candidate cell(s)/at least one LTM candidate cell for transmitting a UL signal to a UL resource occasion (e.g., PRACH occasion) of the LTM candidate cell, wherein the UL resource occasion in which the UE transmits the UL signal occurs between the reception of the trigger and the first synchronization signal (e.g., SSB) of the LTM candidate cell after the trigger, wherein the selection of the subset of the LTM candidate cell(s) is based on one or more rules (or combination of these). In other words, the UE may not be able to perform the actions in the method for all configured cells, so the UE needs to select a subset of cells in which the UE perform the actions. Multiple rules, which may possibly be combined, are presented below, for the selection of the subset of the LTM candidate cell(s).

FIG. 11 depicts an example based on the selection of a subset of LTM candidate cells for performing the UL signal transmission (e.g., PRACH preamble) according to some embodiments, for the case of TA establishment/update procedure.

Certain embodiments may provide one or more of the following technical advantage(s). By utilizing the disclosed subject matter, the delay is reduced when transmitting a UL signal to the LTM candidate cell, in a TA establishment/update procedure towards an LTM candidate cell, in preparation for an LTM cell switch without a random access procedure.

When applied to an LTM cell switch, due to the utilization of the disclosed subject matter, the delay is reduced when transmitting a UL signal to the LTM candidate cell, in an LTM cell switch towards an LTM candidate cell, with or without a random access procedure.

The UE can transmit the UL signal (e.g., PRACH preamble) to an LTM candidate cell (indicated by a trigger for TA establishment e.g., PDCCH order, RRC message or MAC from the PCell, or in response to an LTM cell switch) by transmitting in the PRACH occasion (or PUCCH and/or PUSCH) occurring before the next synchronization signal (e.g., SSB) after the UE receives the trigger. In other words, the UE is not required to first receive an SSB (or any other synchronization signal) of the LTM candidate cell to only then transmit in the UL. This reduces the time it takes to perform the UL synchronization for an LTM candidate cell during the TA establishment procedure, which may reduce the time the UE needs to be away from the serving cell(s) and, consequently, possibly improves the throughput/data rates.

That may possibly improve the reliability of the overall UE connection, because a shorter time to perform the TA establishment/update means that the UE is faster back to the PCell, after the PRACH preamble transmission, which means that the UE is ready faster to receive an LTM cell switch command from the PCell.

NOTE: The UE has the freedom to implement the standardized functions in detail in different manners. For one of the examples, for LTM cell switch and TA establishment, when the UE is configured with multiple UL resources (e.g., multiple PRACH occasions and/or PUCCH and/or PUSCH resources) which are available, it is up to the UE implementation to decide the internal actions which are necessary to access the LTM target cell (or to transmit to it, in case of TA establishment) after the network sends the trigger, e.g., how much time the UE needs to make such actions, which is not aware by the network, and the reason why the network configures multiple available resources to leave the implementation freedom to decide how much time it may need.

An alternative would be to the network to configure a single resource happening much late to make sure there is enough time, but that would also significantly increase the interruption time. Notice that the UE could have had other alternatives, and it would not be mandated for the UE to access the first resource before the next SSB.

### BRIEF DESCRIPTION OF THE DRAWINGS

FIG. 1 illustrates a time alignment of uplink transmissions for a case (a) without timing advance and for a case (b) with timing advance.

FIG. 2 illustrates a timeline for L1/L2 inter-cell mobility.

FIG. 3 illustrates an example of a procedure for establishing timing alignment (TA).

FIG. 4 illustrates an example of a procedure for establishing timing alignment (TA) according to some embodiments.

FIG. 5 illustrates the delay for TA establishment with an LTM candidate cell.

FIG. 6 illustrates a LTM cell switch procedure based on a Random Access procedure.

FIG. 7 illustrates a LTM cell switch procedure which is not based on a Random Access procedure.

FIG. 8 illustrates TA establishment with an LTM candidate cell according to some embodiments.

FIG. 9 illustrates TA establishment with an LTM candidate cell relying on random access

FIG. 10 illustrates TA establishment with an LTM candidate cell not relying on not relying on PUCCH and/or PUSCH transmissions in accordance with some embodiments.

FIG. 11 illustrates an example based on the selection of a subset of LTM candidate cells for performing the UL signal transmission in accordance with some embodiments.

FIG. 12 illustrates a signaling diagram for a TA establishment with an LTM candidate cell in accordance with some embodiments.

FIG. 13 illustrates a signaling diagram for a LTM cell switch.

FIG. 14 illustrates transmission of the HARQ feedback triggered by PDCCH monitoring in the LTM candidate cells.

FIG. 15 illustrates a method performed by a UE in a wireless communication network for performing TA with a LTM candidate cell according to some embodiments.

FIG. 16 illustrates a method performed by a network node in a wireless communication network for L1/L2 based inter-cell mobility of a UE to a candidate cell according to some embodiments.

FIG. 17 shows an example of a communication system in accordance with some embodiments.

FIG. 18 shows an example of a UE in accordance with some embodiments.

FIG. 19 shows an example of a network node in accordance with some embodiments.

FIG. 20 is a block diagram of a host.

FIG. 21 is a block diagram illustrating a virtualization environment.

FIG. 22 is a communication diagram of a host.

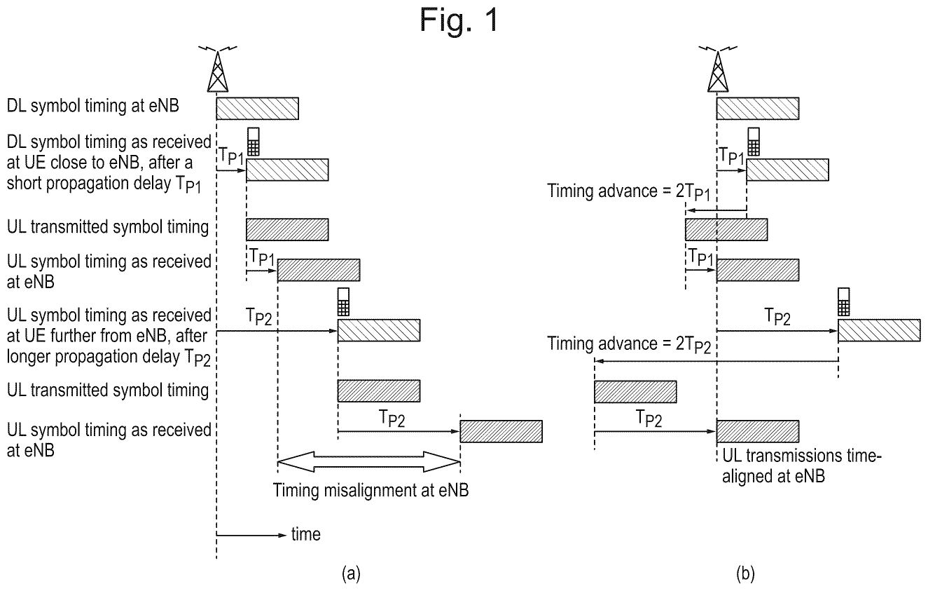

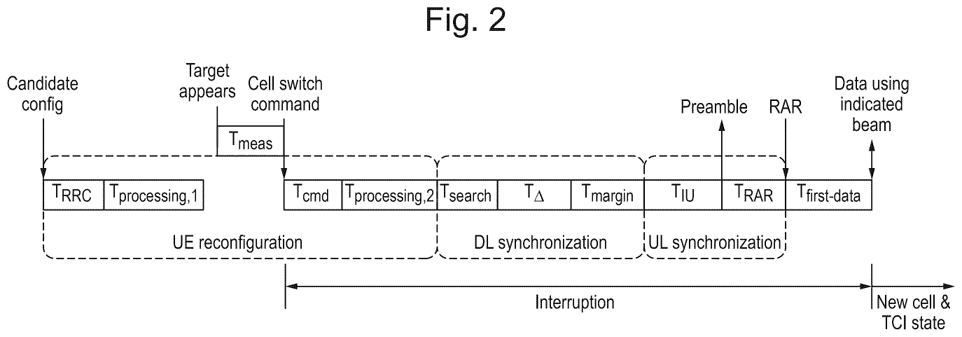

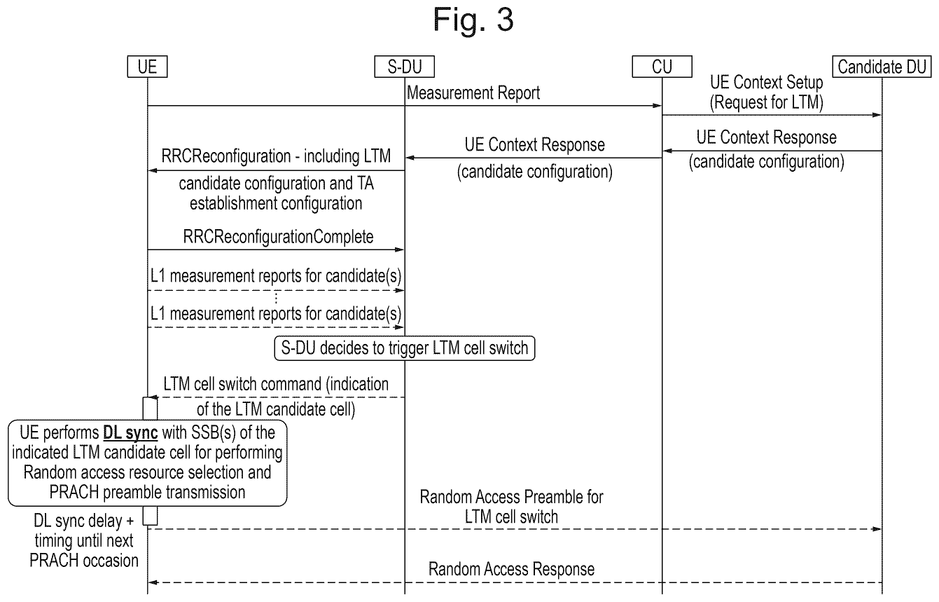

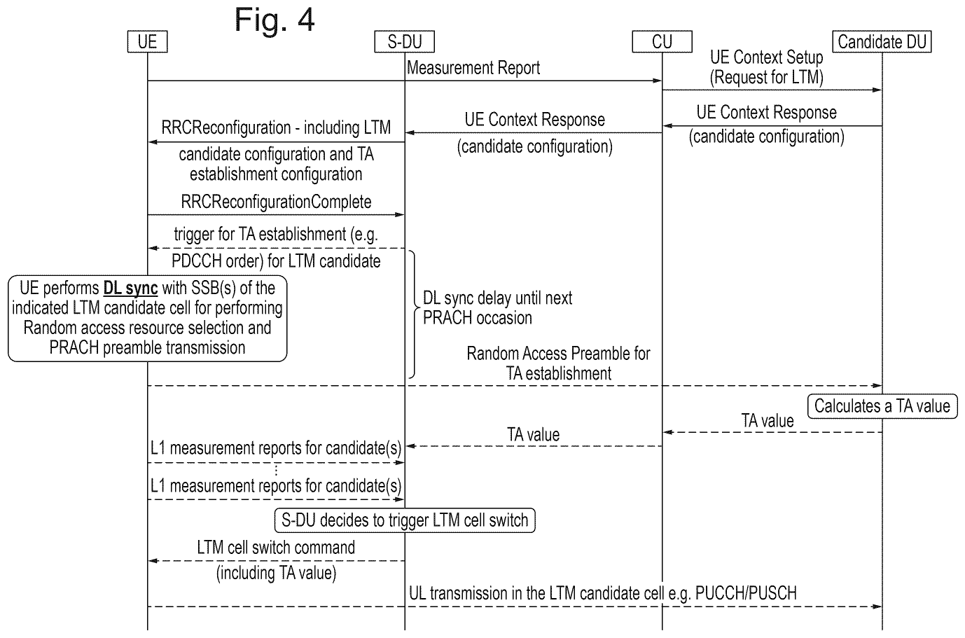

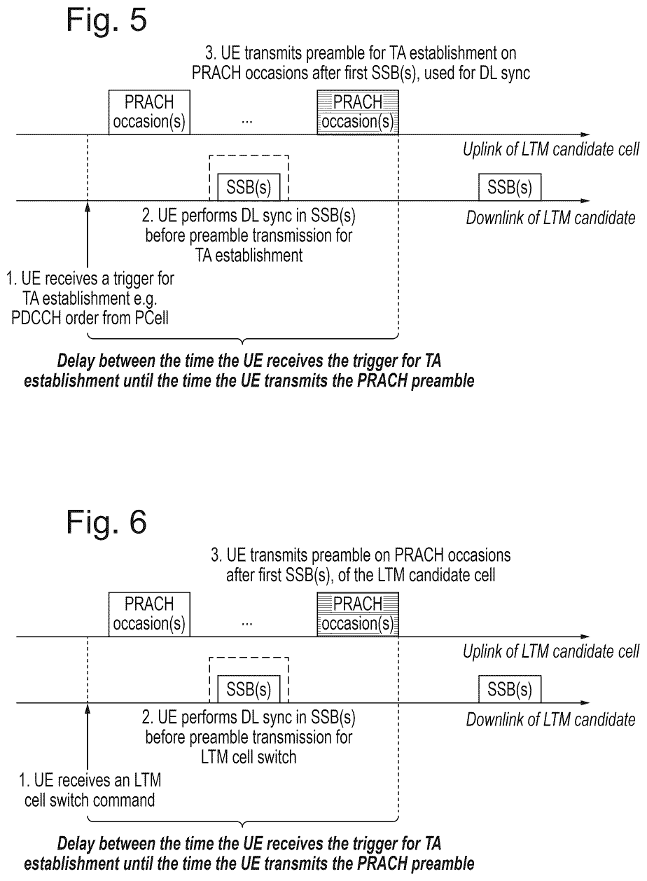

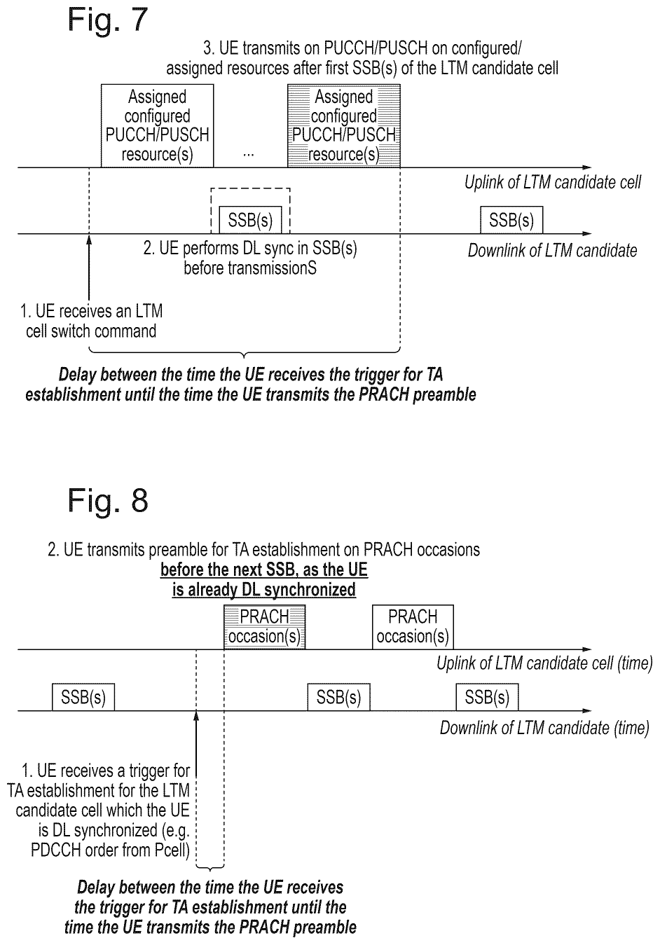

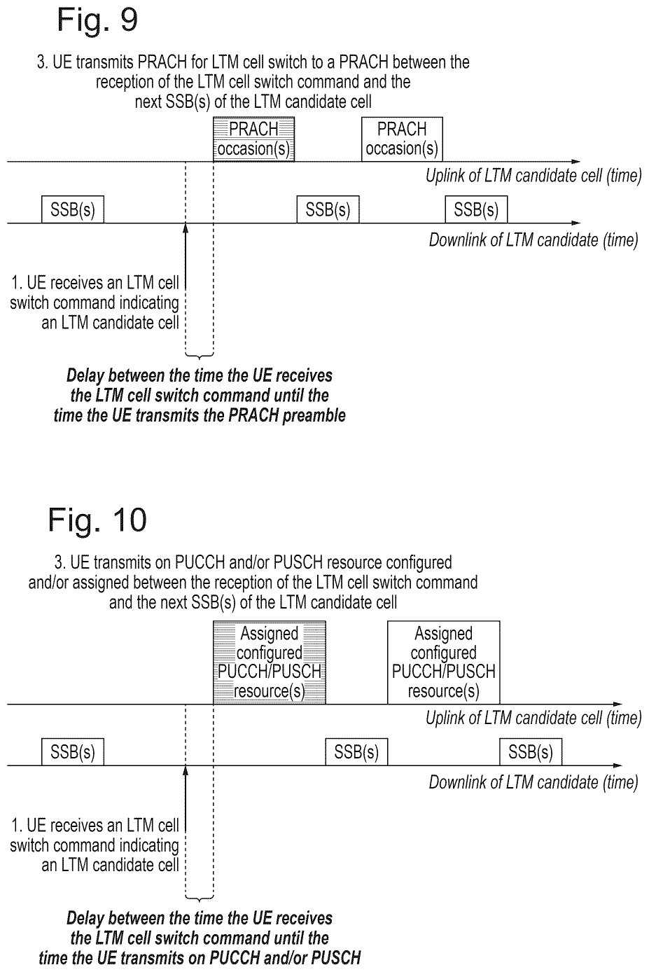

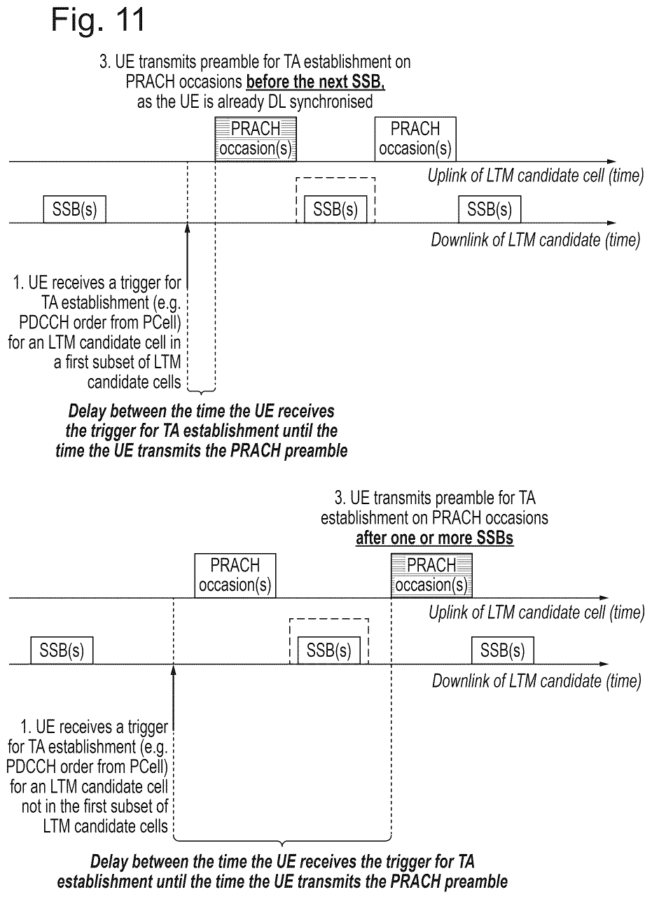

### DETAILED DESCRIPTION

Some of the embodiments contemplated herein will now be described more fully with reference to the accompanying drawings. Embodiments are provided by way of example to convey the scope of the subject matter to those skilled in the art.

### Scenario and Terminology for the Embodiments

The text herein refers to the term “L1/L2 based inter-cell mobility” as used in the Work Item Description in 3GPP, though it interchangeably also uses the terms L1/L2 mobility, L1-mobility, L1 based mobility, L1/L2-centric inter-cell mobility, L1/L2 inter-cell mobility, or L1/L2 triggered Mobility (LTM).

The basic principle of LTM is that the UE is first configured with one or more LTM candidate cells (via RRC) and later, e.g., after the UE reports L1 measurements on one or more LTM candidate cells, the UE receives a lower layer signaling from the network indicating to the UE a change (or switch or activation) of its serving cell (e.g., change of PCell, from a source to a target PCell), wherein a lower layer signaling is a message/signaling of a lower layer protocol, which may be referred as a L1/L2 inter-cell mobility execution command (or LTM cell switch command). The change of serving cell (e.g., change of PCell) may also lead to a change in SCell(s) for the same cell group e.g., in case the command triggers the UE to change to another cell group configuration of the same type (e.g., another MCG configuration). Before the UE receives the LTM cell switch command, the UE is configured by the network with one or more LTM candidate cells (e.g., reception of an RRC Reconfiguration message, with at least one candidate cell configuration) A candidate cell configuration may include parameters in the IE CellGroupConfig per candidate cell and/or an embedded RRC Reconfiguration per candidate cell.

A lower layer protocol refers to a lower layer protocol in the air interface protocol stack compared to RRC protocol, e.g., Medium Access Control (MAC) is considered a lower layer protocol as it is “below” RRC in the air interface protocol stack, and in this case a lower layer signaling/message may correspond to a MAC Control Element (MAC CE). Another example of lower layer protocol is the Layer 1 (or Physical Layer, L1), and in this case a lower layer signaling/message may correspond to a Downlink Control Information (DCI). Signaling information in a protocol layer lower than RRC reduces the processing time and, consequently, reduces the interruption time during mobility. In addition, it may also increase the mobility robustness as the network may respond to faster changes in the channel conditions. Another relevant aspect in L1/L2 inter-cell mobility is that in multi-beam scenario, a cell can be associated to multiple SSBs, and during a half-frame, different SSBs may be transmitted in different spatial directions (i.e., using different beams, spanning the coverage area of a cell). Similar reasoning may be applicable to CSI-RS resources, which may also be transmitted in different spatial directions. Hence, in L1/L2 inter-cell mobility (LTM), the reception of a lower layer signaling indicates the UE to change from one beam in the serving cell, to another beam in a neighbor cell (which is a configured candidate cell), and by that changing serving cell.

The term LTM cell switch procedure (or simply cell switch) refers to the process of a UE changing its cell from a source cell to a target cell (which may be called here a candidate cell), using L1/L2-triggered mobility (also called here LTM). In the context of L1/L2 based inter-cell mobility or L1/L2-triggered mobility (LTM), LTM cell switch procedure may sometimes also be known as dynamic switch, LTM switch, LTM cell switch, LTM serving cell change or LTM cell change. Even if the term change of cell is used, that may comprise a change of a whole cell group configuration, which includes a change in the SpCell (e.g., change of PCell, or change of PSCell) and a change in SCells of the cell group (e.g., addition, modification and/or release of one or more SCells).

The text refers to the term “LTM candidate cell” to refer to a cell the UE is configured with when configured with L1/L2 inter-cell mobility. That is a cell the UE can move to in a L1/L2 inter-cell mobility procedure, upon reception of a lower layer signaling. These cells may also be called candidate cells, candidates, mobility candidates, non-serving cells, additional cells, etc. This is a cell the UE perform measurements on (e.g., L1-RSRP measurements or CSI measurements) as disclosed in the disclosed subject matter, so that the UE reports these measurements and network may take educated decision on which beam (e.g., TCI state) and/or cell the UE is to be switched to. A L1/L2 inter-cell mobility candidate cell may be a candidate to be a target PCell, PSCell, or an SCell of a cell group (e.g., MCG SCell). In that sense, when the text refers to a resource configuration to indicate SSs and/or RSs for the UE to measure for CSI for reporting, it may be referring to SSs and/or RSs of a candidate SCell of the MCG, a candidate SCell of the SCG, a candidate PSCell and/or a candidate PCell.

According to the method, related to LTM, a UE may be capable of acquiring Downlink (DL) and/or Uplink (UL) synchronization before receiving the LTM cell switch command (e.g., MAC CE indicating an LTM candidate cell and/or LTM candidate cell configuration). For a UE which is capable of acquiring DL synchronization before receiving the LTM cell switch command, there may be limitation on the number of cells UE can acquire such a synchronization before receiving the LTM cell switch command. Also, for acquiring the UL synchronization, the UE may need to transmit UL signals such as PRACH preamble or Sounding Reference Signal (SRS) to the LMT candidate cell (e.g., of a target gNB and/or Candidate DU). Unless the UE has acquired DL synchronization, the UE does not transmit PRACH or SRS to acquire the UL synchronization. Each PRACH preamble may be associated with an SSB and a RACH occasion (RO) where the preamble can be transmitted. The RO can be a periodically repeating occasion. For example, if the first RO associated with a PRACH preamble is at 10 ms, then the 2nd RO associated with the same preamble may be at 10 ms+(160 ms) and the 3rd RO associated with the same preamble may be at 10 ms+(2*160 ms), and the 4th RO is 10 ms+(3*160 ms), etc.

In a set of embodiments the disclosed subject matter includes the steps of a method comprising a UE receiving a configuration of one or more LTM candidate cells, and receiving a trigger and in response to the trigger transmitting a UL signal to a UL resource occasion (e.g., PRACH occasion) of the LTM candidate cell, wherein the UL resource occasion in which the UE transmits the UL signal occurs between the reception of the trigger and the first synchronization signal (e.g., SSB) of the LTM candidate cell after the trigger.

The reasoning for transmitting the UL signal between the reception of the trigger and the first synchronization signal (e.g., SSB) of the LTM candidate cell after the trigger, i.e., before the next synchronization signal (e.g., before the next SSB), is that it would not be necessary in case the UE is DL synchronized with the LTM candidate cell, so that the UE can transmit in the next available PRACH occasion or assigned/configured PUCCH/PUSCH resource(s) of the LTM candidate cell after the UE receives the trigger from the serving cell.

According to the method the trigger may correspond to one or more of:
a trigger for a TA establishment/update procedure, wherein the trigger is received from a serving cell (e.g., a PDCCH order from the Primary Cell, or Primary SCG cell) to transmit a UL signal (e.g., PRACH preamble) for TA establishment/update;
a trigger for an LTM cell switch procedure, wherein the trigger corresponds to an LTM cell switch command (indicating an LTM candidate cell e.g., LTM configuration ID) from a serving cell (e.g., a MAC CE from the Primary Cell, or Primary SCG cell) to access the LTM candidate.

According to the method the UL signal may correspond to one or more of:
a PRACH preamble transmitted to a PRACH occasion of the LTM candidate cell in an LTM cell switch;
a PRACH preamble transmitted to a PRACH occasion of the LTM candidate cell in an TA establishment/update procedure;
a Sounding Reference Signal (SRS) transmitted to a PUCCH or PUSCH of the LTM candidate cell in an TA establishment/update procedure;
a control information (e.g., scheduling request) transmitted on a Physical Uplink Control Channel (PUCCH) of the LTM candidate cell in an LTM cell switch procedure; and/or
UL data (e.g., including as payload an RRC Reconfiguration Complete) transmitted on a Physical Uplink Shared Channel (PUSCH) of the LTM candidate cell in an LTM cell switch procedure;

According to the method the UL resource occasion may correspond to one or more of:
A PRACH occasion of the LTM candidate cell;
A Physical Uplink Control Channel (PUCCH) resource or resource occasion of the LTM candidate cell which has been configured (e.g., in the RRC configuration of the LTM candidate cell) and/or assigned (e.g., in the LTM cell switch command);
A Physical Uplink Shared Channel (PUSCH) resource or resource occasion of the LTM candidate cell which has been configured (e.g., in the RRC configuration of the LTM candidate cell) and/or assigned (e.g., in the LTM cell switch command).

According to the method, the UE is configured with multiple LTM candidate cell(s) (i.e., more than one candidate cell) and selects a subset of the LTM candidate cell(s)/at least one LTM candidate cell for transmitting a UL signal to a UL resource occasion (e.g., PRACH occasion) of the LTM candidate cell, wherein the UL resource occasion in which the UE transmits the UL signal occurs between the reception of the trigger and the first synchronization signal (e.g., SSB) of the LTM candidate cell after the trigger, wherein the selection of the subset of the LTM candidate cell(s) is based on one or more rules (or combination of these). In other words, the UE may not be able to perform the actions in the method for all configured cells, so the UE needs to select a subset of cells in which the UE perform the actions. Multiple rules, which may possibly be combined, are proposed below, for the selection of the subset of the LTM candidate cell(s).

According to the method, the UE transmitting the UL signal to the LTM candidate cell in a configured UL channel resource(s) in time and frequency, such as a PRACH occasion happening between the reception of the trigger and the occurrence of the next synchronization signal (e.g., SSB) in the LTM candidate cell is based on DL synchronization performed before the reception of the trigger to the LTM candidate cell.

The UE performing DL synchronization (also called DL pre-synchronization, pre-synchronization, pre-sync) with an LTM candidate cell comprises the UE detecting and/or measuring at least one synchronization signal of the LTM candidate cell, such as an Synchronization Signal Block (SSB), e.g., an SSB of the LTM candidate cell associated to an SSB index and/or identifier and transmitted in a spatial direction (beam), and/or a Channel State Information-Reference Signal (CSI-RS) and/or a Tracking Reference Signal (TRS) and/or a Primary Sync Signal (PSS) and/or a Secondary Sync Signal (SSS); in this context, measuring comprises determining a measurement quantity value such as a Synchronization Signal based Reference Signal Received Power (SS-RSRP) and/or Synchronization Signal based Reference Signal Received Quality (SS-RSRQ) and/or Synchronization Signal based Signal to Noise and Interference Ratio (SS-SINR).

The UE performing DL synchronization with an LTM candidate cell comprises the UE performing fine time tracking and acquiring full timing information of the LTM candidate cell. Timing acquisition comprises obtaining the time boundaries of time units of a given LTM candidate cell such as time slot, OFDM symbol, subframe, radio frame. Timing acquisition comprises synchronizing a clock with the boundaries of time units of a given LTM candidate cell such as time slot, OFDM symbol, subframe, radio frame. The acquired fine timing is used as reference point for PRACH transmission and UE uplink transmissions.

According to the method, the UE is configured with multiple LTM candidate cell(s) (i.e., more than one candidate cell) and selects a subset of the LTM candidate cell(s)/at least one LTM candidate cell for performing DL synchronization before a TA establishment procedure is triggered, wherein the selection of the subset of the LTM candidate cell(s) is based on one or more rules (or combination of these).

According to the method the UE transmits the UL signal to the LTM candidate cell in a configured UL channel resource(s) in time and frequency before the next synchronization signal (e.g., SSB) of the LTM candidate cell, in the first configured UL channel resource(s) in time and frequency (e.g., first PRACH occasion) after the reception of the trigger.

The reason to transmit the UL signal in the first PRACH occasion configured for TA establishment, before the next synchronization signal, is that it would not be necessary in case the UE is DL synchronized with the LTM candidate cell, so that the UE can transmit in the next available PRACH occasion of the LTM candidate cell after the UE receives the trigger for TA establishment from the serving cell e.g., PDCCH order from the PCell.

According to the method, prior to receiving the LTM cell switch command from the serving cell indicating the LTM candidate cell, the UE receives a configuration (e.g., an LTM configuration within an RRC Reconfiguration message) from the serving cell with one or more LTM candidate cell configuration(s), to be applied upon reception of an LTM cell switch command. This is equivalent to the UE being configured with LTM by the network.

According to the method, prior to receiving the LTM cell switch command from the serving cell indicating the LTM candidate cell, the UE receives a configuration for TA establishment/update with the LTM candidate cell, comprising one or more UL related parameters: such as PRACH preamble configuration, PRACH occasion(s), PRACH frequency resource(s), etc. In one option, the configuration for TA establishment/update is included in the same RRC message configuring the UE with LTM, e.g., an RRC Reconfiguration. In another option, the configuration for TA establishment/update is included in a second RRC message while the UE receives a first RRC message configuring the UE with LTM, e.g., a second RRC Reconfiguration.

According to the method, the UE is configured with multiple LTM candidate cell(s) and when the UE receives the trigger to transmit an uplink signal to an LTM candidate cell in a first subset of the multiple LTM candidate cell(s), transmitting the UL signal to the LTM candidate cell in a first subset of the multiple LTM candidate cell(s), in a configured UL channel resource(s) in time and frequency before the next synchronization signal (e.g., SSB) of the LTM candidate cell.

According to the method, the UE is configured with multiple LTM candidate cell(s) and when the UE receives the trigger from a serving cell (e.g., a PDCCH order from the Primary Cell, or Primary SCG cell) to transmit a UL signal (e.g., PRACH preamble) for TA establishment/update to an LTM candidate cell which is not in the first subset of the multiple LTM candidate cell(s), transmitting the UL signal to the LTM candidate cell which is NOT in the first subset of the multiple LTM candidate cell(s), in a configured UL channel resource(s) in time and frequency after the next synchronization signal (e.g., SSB) of the LTM candidate cell.

According to the method, the UE is configured with multiple LTM candidate cell(s) (i.e., more than one candidate cell) and selects a subset of the LTM candidate cell(s)/at least one LTM candidate cell for transmitting the UL according to the method (e.g., in a UL resource occasion between the reception of the trigger and the occurrence of an SSB), wherein the selection of the subset of the LTM candidate cell(s) is based on one or more rules (or combination of these), as follows:

1) the UE Selects all LTM Candidate Cell(s) which the UE is Configured with.

In one option as one of the examples, the UE reports a capability which indicates that the UE is capable of DL synchronization with a number “K” of LTM candidate cells and the UE receives a message (e.g., RRC Reconfiguration) including an LTM configuration for a number “K*” LTM candidate cells with K*<=K, so the UE performs the UL transmission between the reception of the trigger and the next SSB occurrence (e.g., in a TA establishment or LTM cell switch) for all LTM candidates (or any, as a single one may be indicated in the LTM cell switch).

NOTE: there may be a first capability related to the TA establishment procedure and a second capability related to the LTM cell switch procedure.

The capability described above may be reported when the UE transitions from an IDLE state to a CONNECTED state.

Testability/measurability of UE implementation step: As one of the examples, in a test we could configure a number of LTM candidate cells which we know the UE is capable of handling, thanks to the reported UE capability, e.g., 2 cells. Then, we test that when the network transmits the trigger for all or any of these configured LTM candidate cells, the UE indeed transmits the UL signal (e.g., PRACH preamble) in the UL channel occasion (e.g., PRACH occasion) before the next SSB, after reception of the trigger. For that, we would also need to configure an LTM candidate cell which transmits a PRACH occasion between the reception of the trigger and the next SSB.

Test scenario as one of the examples. Serving Cell SC1 and Neighbor Cell NC2 configured as LTM candidate cell with a SSB configured by a known time instant.
Configure different timing for SSB;
   A set of time offsets can be added in as unsync cell from signal generator for NCell to move the SSB in the know time.
   Alternative is to configure SSB in a different time occasions for the NCell in a sequence of tests
Configure to send the LTM cell switch command from SCell 1 at the same time in the tests;
Configure to allow a PRACH occasion for NCell 2;
Check the time instant of the UL PRACH sent to NCell if it follows the timing offset or the different SSB occasions.

### 2) the UE Selects the Strongest LTM Candidate Cells Out of “N” Configured LTM Candidate Cells According to a Measurement Quantity, Wherein a Measurement Quantity May Correspond to RSRP, RSRQ, SINR, Etc.

In one option as one of the examples, the measurement quantity RSRP, RSRQ or SINR.

In one option as one of the examples, the strongest LTM candidate cells are selected based on the cell quality of the LTM candidate cell e.g., UE selects the LTM candidates whose cell RSRP values are the strongest.

In one option as one of the examples, the strongest LTM candidate cells are selected based on a beam/SSB/CSI-RS quality of the LTM candidate cell e.g., UE selects the LTM candidates whose strongest beam level RSRP values (SS-RSRP values) are the strongest.

Testability/measurability of UE implementation step: In a test we could configure the UE to report the measurement quantity for the LTM candidate cells, so the values of that measurement quantity may be observed (e.g., SS-RSRP for the configured LTM candidate cells, so that we can see when that situation does not change; based on the observation, we can transmit the trigger to the UE (e.g., for TA establishment procedure or LTM cell switch) and see whether the UE is selecting the cells for which the reported values are fulfilling the rule number 2).

Test scenario as one of the examples. Serving Cell SC1, Neighbor Cell NC2 as 1st configured LTM candidate cell with a 1st SSB configured by a known 1st time instant, and 2nd Neighbor Cell NC3 as 2nd configured LTM candidate cell with a 2nd SSB configured by a known 2nd time instant. NC 2 is configured with 1st power level 1 corresponding to RSRP 1 and NC3 is configured with 2nd power level 2 corresponding to RSRP 2.
Configure to send the LTM cell switch command from SCell 1 at the same time in the tests;
Configure to allow a PRACH occasion for NC2 and NC3;
Check the time instant of the UL PRACH sent to NC2 or NC3 if it's the strongest RSRP and if the UL PRACH is sent in the time instant between the switch command and the known SSB time instant from either NC2 or NC3.

### 3) the UE Selects “K” Strongest LTM Candidate Cells Out of “N” Configured LTM Candidate Cells According to a Measurement Quantity, Wherein a Measurement Quantity May Correspond to RSRP, RSRQ, SINR, Etc.

In one option as one of the examples, the UE reports a capability which indicates that the UE is capable of DL sync (or DL pre-sync) with a number “K” of LTM candidate cells and the UE receives a message (e.g., RRC Reconfiguration) including an LTM configuration for a number “N” LTM candidate cells with N>K, so that the UE transmits the UL signal in a UL resource occasion between the reception of the trigger and the next SSB occurrence to any of the K strongest LTM candidate cell(s) for a measurement quantity, after receiving the LTM candidate cell configuration and upon reception of the trigger (e.g., for TA establishment procedure or LTM cell switch).

In one option as one of the examples, the measurement quantity RSRP, RSRQ or SINR.

In one option as one of the examples, the K strongest LTM candidate cells are selected based on the cell quality of the LTM candidate cell, e.g., UE selects the LTM candidates whose cell RSRP values are the strongest.

In one option as one of the examples, the K strongest LTM candidate cells are selected based on a beam/SSB/CSI-RS quality of the LTM candidate cell, e.g., UE selects the LTM candidates whose strongest beam level RSRP values (SS-RSRP values) are the strongest.

Testability/measurability of UE implementation step: In the case of TA establishment, it is possible to trigger the UE to perform the procedure with multiple candidates, so that in a test we could trigger the TA establishment to the N candidate cells and possibly observe the UL transmissions in the K fulfilling the conditions in the rule. In order to verify whether the K cells are the strongest, we can configure the UE to periodically transmit L1 and/or L3 measurement reports for the N LTM candidate cells. In a test we could configure the UE to report the measurement quantity for the LTM candidate cells, so the values of that measurement quantity may be observed e.g., SS-RSRP for the configured LTM candidate cells, so that we can see when that situation does not change; based on the observation, we can trigger the TA establishment procedure and see whether the UE is selecting the cells for which the reported values are fulfilling the rule number 3.

For the LTM cell switch the test may be done by configuring the UE to perform L1 measurements or L3 measurements to be reported for all the N candidates and, trigger the LTM cell one by one, so that we may observe that when we trigger the LTM cell switch for any of the K strongest cells the UE transmits the transmits the UL signal in a UL resource occasion between the reception of the trigger and the next SSB occurrence. We could also run the test relying on sub-sequent LTM cell switches, which includes the UE receiving the trigger for LTM, changing to an LTM candidate cell, and, while it is there the UE received another trigger for LTM cell switch, to another LTM candidate cell.

4) The UE selects all LTM candidate cell(s) configured for TA establishment/update, e.g., upon reception of the RRC message including the TA establishment configuration, when the number of LTM candidate cell(s) configured for TA establishment/update do not exceed a UE capability corresponding to a maximum number of cells in which the UE is capable of DL sync before reception of the trigger.

For example, when the UE reports a capability which indicates that the UE is capable of DL sync with a number “K” of LTM candidate cells and the UE receives a message (e.g., RRC Reconfiguration) including an LTM configuration including the TA establishment configuration for a number K* of LTM candidate cells with K*<=K, the UE may transmit to any of the LTM candidate cells, upon reception of the trigger, the UL signal in a UL resource occasion between the reception of the trigger and the next SSB occurrence.

The capability described above may be reported when the UE transitions from an IDLE state to a CONNECTED state.

There may be capability related to the LTM cell switch and another capability related to the TA establishment/update procedure.

Testability/measurability of UE implementation step: In a test we could configure TA establishment for a subset of LTM candidate cells (“K”), trigger the TA establishment procedure for these K cells and verify whether the UE is transmitting the UL signal (e.g., PRACH preamble) to the first PRACH occasion after the reception of the trigger but before the next SSB.

5) The UE selects the LTM candidate cell(s) configured for TA establishment/update with a measurement quantity (e.g., RSRP) which is strong enough e.g., the UE selects the LTM candidate cell(s) configured for TA establishment with strong enough RSRP.

In one option as one of the examples, the measurement quantity may correspond to RSRP, RSRQ, SINR.

In one option as one of the examples, the measurement quantity may correspond to a cell-based measurement quantity, e.g., a cell RSRP for the LTM candidate cell.

In one option as one of the examples, the measurement quantity may correspond to a beam/SSB/CSI-RS based measurement quantity. For example, the UE selects the cells whose strongest SS-RSRP is sufficient/adequate.

Testability/measurability of UE implementation step: In a test we could configure TA establishment for a subset of LTM candidate cells (“K”), trigger the TA establishment procedure for these K cells and verify whether the UE is transmitting the UL signal (e.g., PRACH preamble) to the first PRACH occasion after the reception of the trigger but before the next SSB.

6) The UE selects “K” strongest LTM candidate cells configured for TA establishment out of “N” configured LTM candidate cells configured for TA establishment according to a measurement quantity, wherein a measurement quantity may correspond to RSRP, RSRQ, SINR, etc.

In one option as one of the examples, the UE reports a capability which indicates that the UE is capable of DL sync before a TA establishment or LTM cell switch with a number “K” of LTM candidate cells configured for TA establishment and the UE receives a message (e.g., RRC Reconfiguration) including an LTM configuration for a number “N” LTM candidate cells with N>K, so that the UE transmits to any of the K strongest LTM candidate cells, upon reception of the trigger, the UL signal in a UL resource occasion between the reception of the trigger and the next SSB occurrence, for a measurement quantity.

In one option as one of the examples, the measurement quantity may correspond to RSRP, RSRQ, SINR.

In one option as one of the examples, the K strongest LTM candidate cells are selected based on the cell quality of the LTM candidate cell e.g., UE selects the LTM candidates whose cell RSRP values are the strongest.

In one option as one of the examples, the K strongest LTM candidate cells are selected based on a beam/SSB/CSI-RS quality of the LTM candidate cell, e.g., UE selects the LTM candidates whose strongest beam level RSRP values (SS-RSRP values) are the strongest.

8) the UE Selects One or More LTM Candidate Cell(s) Based on Latest L1 Measurement Reports, e.g., SS-RSRP of an LTM Candidate Cell which has been Reported.

In one option as one of the examples, the UE is configured to perform L1 measurements on one or more LTM candidate cells e.g., CSI measurements, SS-RSRP measurements, etc. Then, the UE selects the LTM candidate cells as the cells for which the UE has transmitted the L1 reports. The reasoning could be that these are also the LTM candidate cells which are more likely to be requested from the network (e.g., S-DU) for TA establishment and/or LTM cell switch.

In one option as one of the examples, the UE does that with a number of LTM candidate cells before its capability in terms of the number of cells for performing DL sync or pre-sync is exceeded.

Testability/measurability of UE implementation step: In a test we could configure the UE to transmit L1 reports for an LTM candidate cell, and trigger the TA establishment (or LTM cell switch) shortly after, and verify whether for that cell the UE is transmitting the PRACH preamble in the first PRACH occasion and/or in the PRACH occasion between the reception of the trigger for TA establishment and the next SSB of the LTM candidate cell.

### 9) the UE Selects One or More LTM Candidate Cell(s) Based on L3 Measurements e.g., Cell Based RSRP of an LTM Candidate Cell.

In one option as one of the examples, the UE is configured to perform L3 measurements on one or more LTM candidate cells, e.g., Radio Resource Management (RRM) measurements like L3 filtered cell based RSRP, RSRQ, SINR. Then, the UE selects the LTM candidate cells as the cells for which the UE has transmitted a L3 measurement report, e.g., triggered cells, fulfilling the condition(s) of an event configured in the reporting configuration e.g., A3 or A5 event. The reasoning could be that these triggered cells fulfilling the event(s) may be configured as LTM candidate cells by the network and be requested from the network (e.g., S-DU) for TA establishment.

In one option as one of the examples, the UE does that with a number of neighbor cells (e.g., which are triggered cells) before its capability is exceeded e.g., the UE reports a number of cells up to the number of LTM candidate cells in which the UE can perform DL sync before the TA establishment.

In one option as one of the examples, the UE updates the neighbor cells (e.g., triggered cells) in which the UE performs DL sync, depending on the cells which are being reported.

Testability/measurability of UE implementation step: In a test we could configure the UE to transmit L3 reports for an LTM candidate cell (e.g., periodic), and trigger the TA establishment shortly after, and verify whether for that cell the UE is transmitting the PRACH preamble in the first PRACH occasion and/or in the PRACH occasion between the reception of the trigger for TA establishment and the next SSB of the LTM candidate cell.

12) UE Selects Cells in Higher Frequencies and/or in a Specific Frequency Range e.g., FR2 Cells, as these could Take Longer to Perform DL Sync and/or to Measure.

In one option as one of the examples, the UE selects one or more LTM candidate cells (or a subset of the LTM candidate cells) whose SSB(s) are in high frequencies and/or in a specific frequency range (FR2).

The reasoning is that for these cells, it may take longer to obtain DL sync so that if the UE waits for the trigger to transmit the UL signal and first needs to perform DL sync, it can take too much time.

Testability/measurability of UE implementation step: In a test we could configure the UE with LTM candidate cells in different frequency ranges and observe that for certain frequency ranges (e.g., FR2), upon the trigger for TA establishment, the UE is transmitting the UL signal (e.g., PRACH preamble) in the PRACH occasion between the trigger and the next SSB of the LTM candidate happening after the trigger.

13) UE Selects Cells with “Long” SSB Periodicity.

In one option as one of the examples, the UE performs DL sync for an LTM candidate cell (or a subset of the LTM candidate cells) whose SSB(s) are with long periodicity e.g., above 20 ms.

In one option as one of the examples, the long periodicity is configured (e.g., periodicity threshold), so that the UE performs DL sync to cells with periodicity longer than the configured value.

The reasoning is that for these cells, it may take longer to obtain DL sync so that if the UE waits for the trigger to transmit the UL signal and first needs to perform DL sync, it can take too much time.

Testability/measurability of UE implementation step: In a test we could configure the UE with LTM candidate cells with different periodicities, longer and shorter, and observe that for longer periodicities (e.g., 50 ms an beyond), upon the trigger for TA establishment, the UE is transmitting the UL signal (e.g., PRACH preamble) in the PRACH occasion between the trigger and the next SSB of the LTM candidate happening after the trigger.

According to the method, the one or more rules may be based on one or more parameters the UE is configured with. The UE may receive the configuration of the one or more parameters in an RRC Reconfiguration message, wherein the one or more parameters may be set for one or more LTM candidate cell(s).

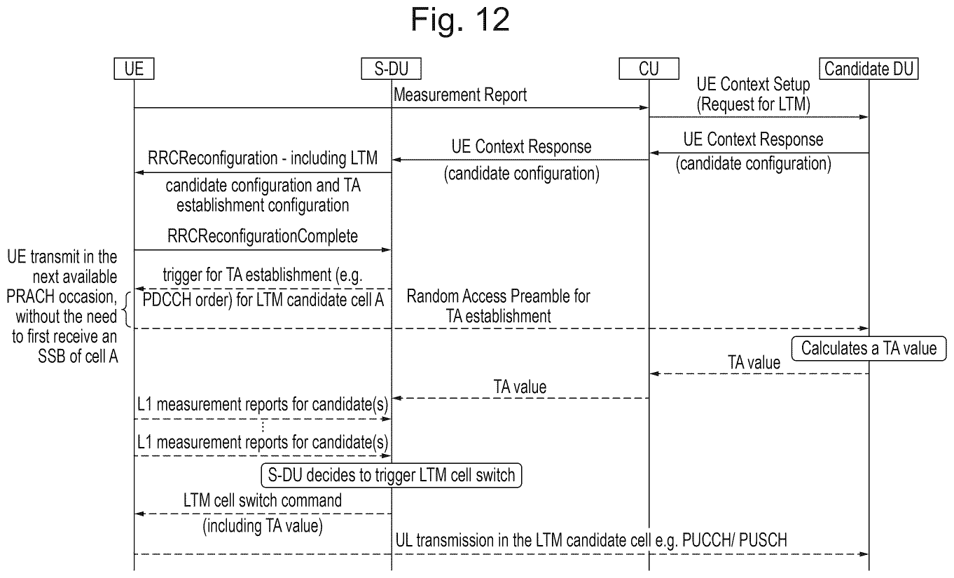

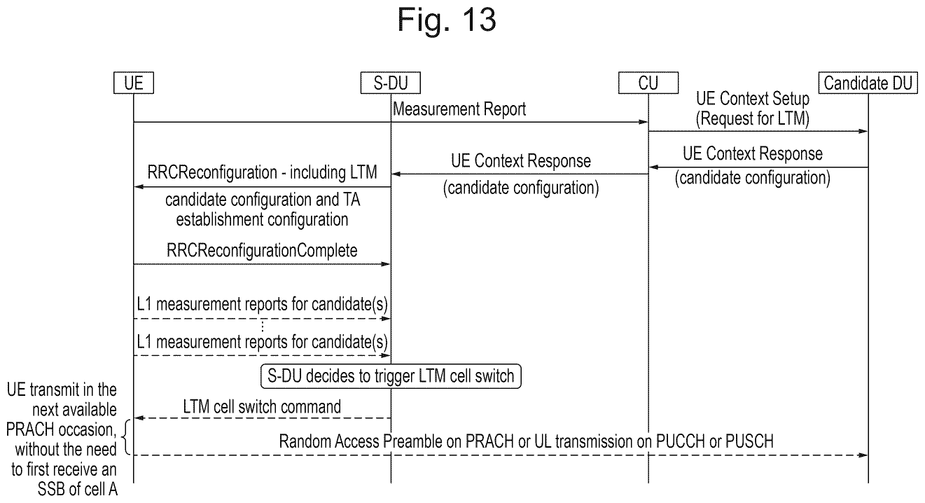

Examples of signaling flows for the method are shown in FIG. 12 and FIG. 13, where the method is applied for the TA establishment procedure. The trigger may correspond to a PDCCH order for an LTM candidate cell or to a LTM cell switch command, with some of the steps also performed by network nodes involved, such as the Source DU (S-DU), the Central Unit (CU) and the Candidate DU (C-DU).

In a set of embodiments, the UE receives a configuration of one or more LTM candidate cells, then, the UE receives the LTM cell switch command and in response to the LTM cell switch command, the UE transmits a UL signal (e.g., HARQ control information) to a UL channel (e.g., PUCCH) to the LTM candidate cell, wherein the UL signal comprise a scheduling request for transmitting a Hybrid Automatic Repeat Request (HARQ) feedback.

In one embodiment the UE receives the LTM cell switch command and in response to the LTM cell switch command, the UE receives information on a DL control channel (e.g., PDCCH) occasion (e.g., a given frame/subframe/time-slot/one or more OFDM symbols), such as a Downlink Control Indication (DCI) indicating a DL data channel (e.g., PDSCH) with downlink data, so that in response the UE needs to transmit a HARQ feedback. To transmit that HARQ feedback the UE transmits the scheduling request on PUCCH. According to the method, the DL control channel occasion occurs between the reception of the LTM cell switch and the first synchronization signal (e.g., SSB) of the LTM candidate cell after the trigger.

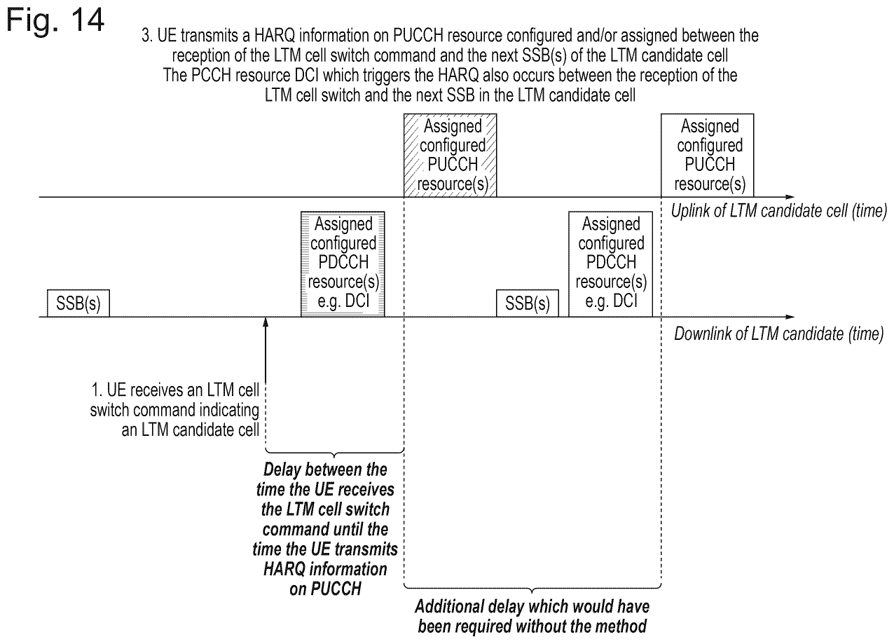

FIG. 14 illustratively shows some embodiments, where the additional delay introduced without the method is shown. Without the method, which could rely on the UE performing a DL pre-synchronization with an SSB of the LTM candidate cell before receiving the trigger, the UE would have to wait for an SSB of the LTM candidate cell after the reception of the trigger, to then monitor PDCCH, search for a DCI and obtain downlink data on PDSCH, to only then transmit the HARQ feedback on PUCCH.

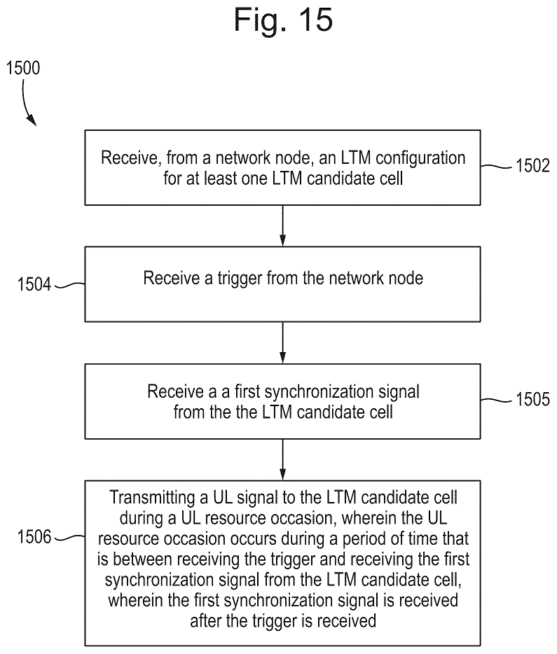

FIG. 15 is a flow chart illustrating an exemplary method 1500 for conducting UL access, such as fast UL access, to a LTM candidate cell. Referring to FIG. 15, in block 1502, the method includes receiving, from a network node, an LTM configuration for at least one LTM candidate cell. In some embodiments, a UE is configured to receive the LTM configuration from the network node. In block 1504, the method includes receiving a trigger from the network node. In some embodiments, the UE is configured to receive the trigger from the network node. In block 1506, the method includes, in response to receiving the trigger, utilizing data in the LTM configuration to transmit a UL signal during a UL resource occasion (e.g., PRACH occasion) corresponding to the LTM candidate cell, wherein the UL resource occasion occurs during a period of time that is between receiving the trigger and a first synchronization signal (e.g., SSB) of the LTM candidate cell that occurs after the trigger is received. In some embodiments, the UE is configured to transmit the UL signal during the UL resource occasion in response to receiving the trigger.

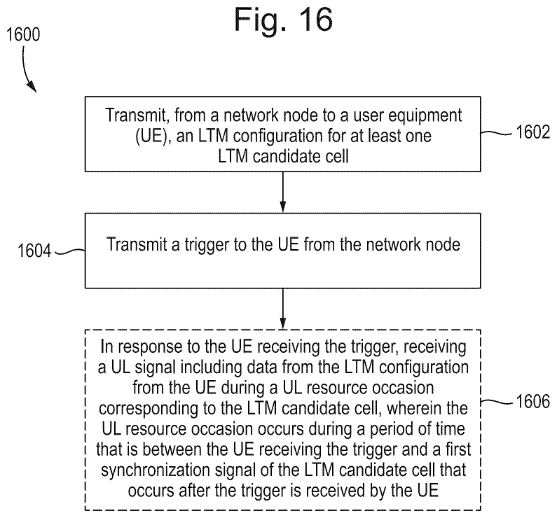

FIG. 16 is a flow chart illustrating an exemplary method 1600 for a network node to cause a UE to conduct fast UL access on a LTM candidate cell. Referring to FIG. 16, in block 1602, the method includes transmitting, from a network node to a UE, an LTM configuration for at least one LTM candidate cell. In block 1604, the method includes transmitting a trigger to the UE from the network node. In some embodiments, the UE is configured to receive the trigger from the network node. In block 1606, the method may optionally include, in response to the UE receiving the trigger, receiving by the network node a UL signal including data from the LTM configuration from the UE during a UL resource occasion (e.g., PRACH occasion) corresponding to the LTM candidate cell, wherein the UL resource occasion occurs during a period of time that is between the UE receiving the trigger and a first synchronization signal (e.g., SSB) of the LTM candidate cell that occurs after the trigger is received by the UE.

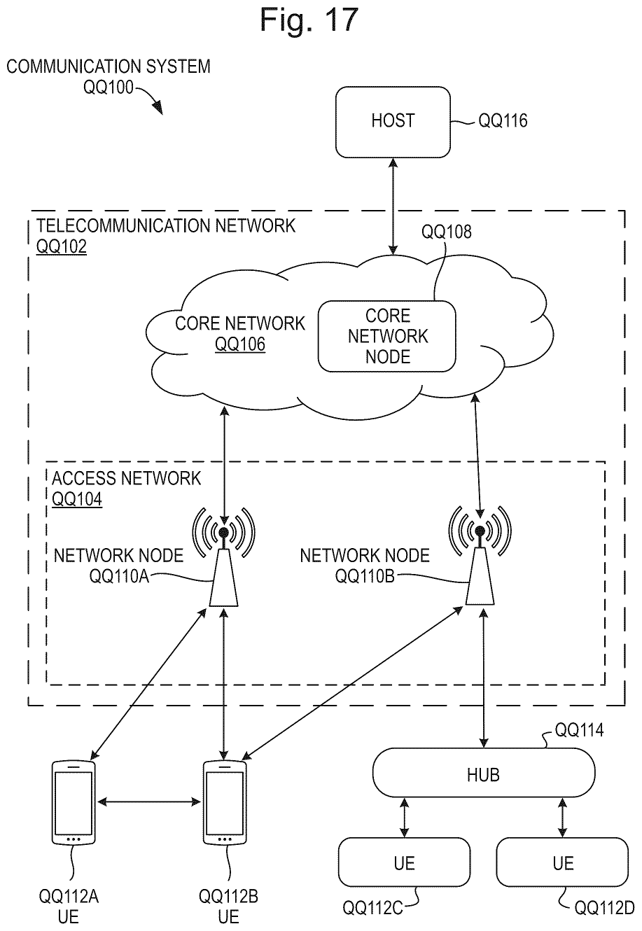

FIG. 17 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of Figure QQ1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

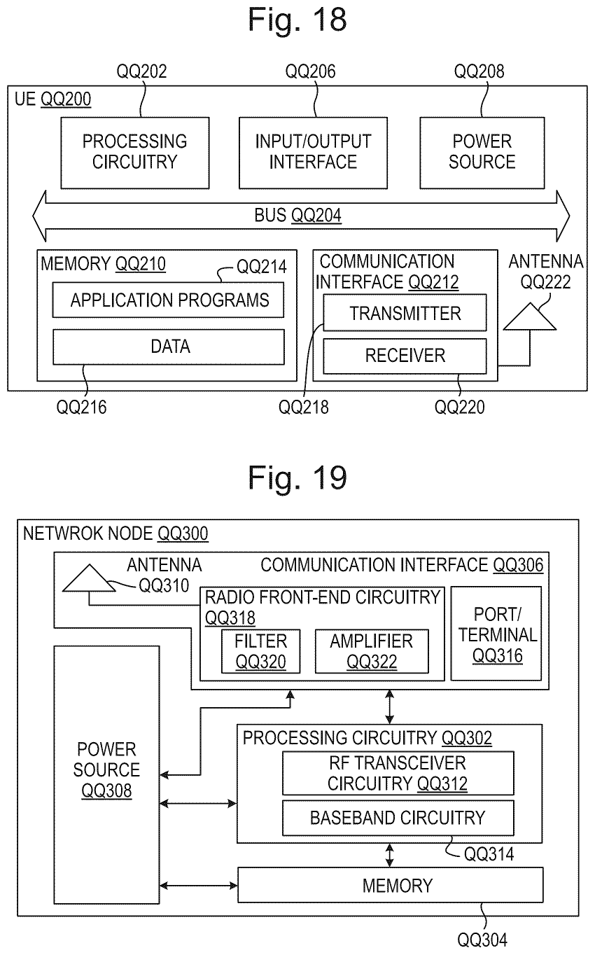

FIG. 18 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in Figure QQ2. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 are integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 19 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

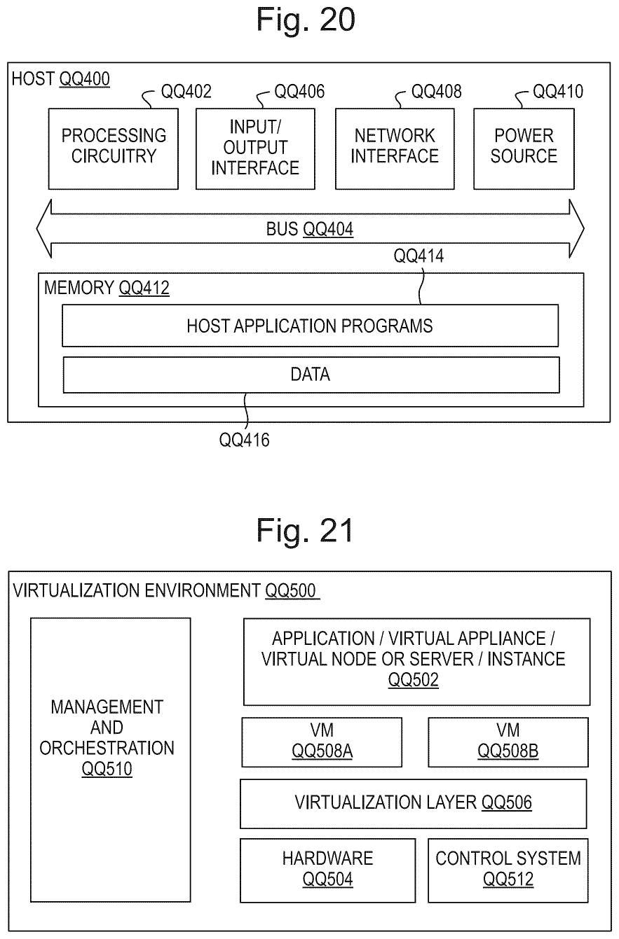

FIG. 20 is a block diagram of a host QQ400, which may be an embodiment of the host QQ116 of FIG. 17, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 18 and 19, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g., such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

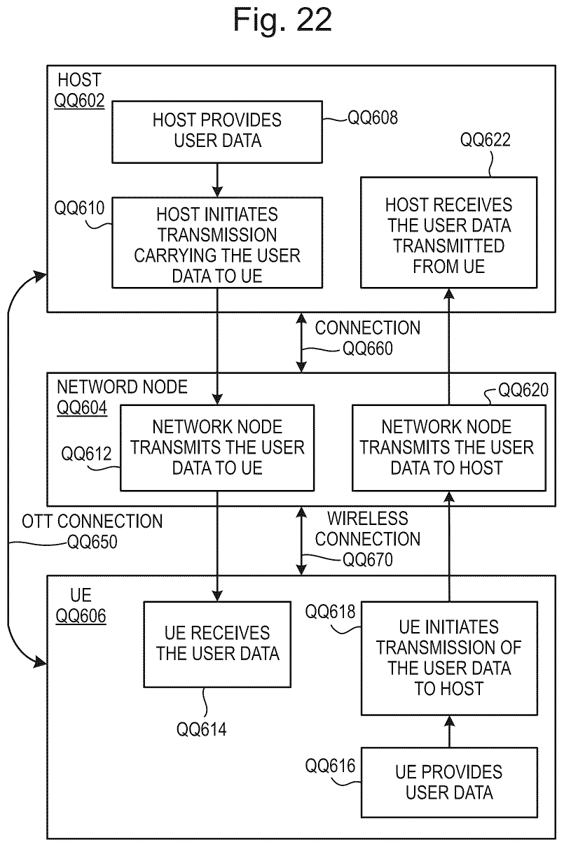

FIG. 22 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 17 and/or UE QQ200 of FIG. 18), network node (such as network node QQ110a of FIG. 17 and/or network node QQ300 of FIG. 19), and host (such as host QQ116 of FIG. 17 and/or host QQ400 of FIG. 20) discussed in the preceding paragraphs will now be described with reference to FIG. 22.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 17) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may reduce the delay when transmitting a UL signal to a LTM candidate cell during a TA establishment/update procedure, and thereby provide benefits such as reduced user waiting/connection time(s), better responsiveness, and improving the reliability of the overall UE connection.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### FURTHER EMBODIMENTS

### Group A Embodiments

A1. A method performed by a user equipment (UE) for conducting fast Uplink (UL) access on a L1/L2 triggered inter-cell mobility (LTM) candidate cell, the method comprising:
receiving (1502), from a network node, an LTM configuration for at least one LTM candidate cell;
receiving (1504) a trigger from the network node; and
in response to receiving the trigger, utilizing (1506) data in the LTM configuration to transmit a UL signal during a UL resource occasion (e.g., PRACH occasion) corresponding to the LTM candidate cell, wherein the UL resource occasion occurs during a period of time that is between receiving the trigger and a first synchronization signal (e.g., SSB) of the LTM candidate cell that occurs after the trigger is received.

A2. The method of embodiment A1, wherein the trigger comprises at least one of an RRC message, IE, field, parameter, MAC Control Element (MAC CE) or PDCCH order, wherein the trigger corresponds to one or more of:
a trigger for a time alignment (TA) establishment/update procedure, wherein the trigger is received from the network node in a serving cell (e.g., a PDCCH order from the Primary Cell or Primary SCG cell) instructing the UE to transmit a UL signal (e.g., PRACH preamble) for the TA establishment/update procedure; and/or
a trigger, from the network node in a serving cell (e.g., a MAC CE from the Primary Cell or Primary SCG cell), for an LTM cell switch procedure, wherein the trigger corresponds to an LTM cell switch command that indicates the LTM candidate cell (e.g., LTM configuration ID) the UE is to access.

A3. The method of any of embodiments A1 or A2, wherein the trigger corresponds to a MAC Control Element (MAC CE), a Downlink Control Indication (DCI), Layer 1 (L1) signaling, Layer 2 (L2) signaling, L1/L2 signaling, and indicates at least one of the configured LTM candidate cells (e.g., LTM candidate ID, or LTM configuration ID).

A4. The method of any of embodiments A1 to A3, wherein the UL signal comprises one or more of:
a PRACH preamble transmitted to a PRACH occasion of the LTM candidate cell in an LTM cell switch;
a PRACH preamble transmitted to a PRACH occasion of the LTM candidate cell in a time alignment (TA) establishment/update procedure;
a Sounding Reference Signal (SRS) transmitted to the LTM candidate cell in an TA establishment/update procedure;
a control information (e.g., scheduling request) transmitted on a Physical Uplink Control Channel (PUCCH) of the LTM candidate cell in a LTM cell switch procedure; and/or
UL data (e.g., including as payload a RRC Reconfiguration Complete) transmitted on a Physical Uplink Shared Channel (PUSCH) of the LTM candidate cell in an LTM cell switch procedure.

A5. A method of any of embodiments A1 to A4, wherein the UL resource occasion comprises one or more of:
a PRACH occasion of the LTM candidate cell;
a Sounding Reference Signal resource or resource occasion of the LTM candidate cell that has been configured (e.g., in the RRC configuration of the LTM candidate cell) and/or assigned (e.g., in the LTM cell switch command);
a Physical Uplink Control Channel (PUCCH) resource or resource occasion of the LTM candidate cell that has been configured (e.g., in the RRC configuration of the LTM candidate cell) and/or assigned (e.g., in the LTM cell switch command); and/or
a Physical Uplink Shared Channel (PUSCH) resource or resource occasion of the LTM candidate cell that has been configured (e.g., in the RRC configuration of the LTM candidate cell) and/or assigned (e.g., in the LTM cell switch command).

A6. The method of any of embodiments A1 to A5, wherein the UE transmitting the UL signal to the LTM candidate cell in a configured UL channel resource(s) in a time and frequency before the next synchronization signal (e.g., SSB) of the LTM candidate cell, comprises the UE transmitting the UL signal in the first configured UL channel resource(s) in a time and frequency (e.g., first PRACH occasion) after the reception of the trigger.

A7. The method of any of embodiments A1 to A6, wherein prior to receiving the trigger, the UE receives a configuration from the serving cell with one or more LTM candidate cell configuration(s) to be applied upon receiving an LTM cell switch command.

A8. The method of any of embodiments A1 to A7, wherein prior to receiving the trigger, the UE receives a configuration for time alignment establishment/update with the LTM candidate cell, wherein the configuration comprises one or more UL related parameters: such as a PRACH preamble configuration, a PRACH occasion(s), a PRACH frequency resource(s), and/or the like.

A9. The method of any of embodiments A1 to A8, wherein the UE is configured with multiple LTM candidate cell(s) and when the UE receives the trigger to transmit a UL signal to an LTM candidate cell which is not in a first subset of the multiple LTM candidate cell(s), transmitting the UL signal to the LTM candidate cell that is not in the first subset, in a configured UL channel resource(s) in a time and frequency after the next synchronization signal (e.g., SSB) of the LTM candidate cell.

A10. The method of any of embodiments A1 to A9, wherein prior to receiving the trigger the UE performs a Downlink (DL) synchronization (or pre-synchronization) with the at least one of the LTM candidate cells, wherein the DL synchronization comprises one or more of:
i) detecting and/or measuring at least one synchronization signal of the LTM candidate cell, wherein the at least one synchronization signal includes an SSB of the LTM candidate cell associated to an SSB index and/or identifier and transmitted in a spatial direction (beam), and/or a CSI-RS and/or a TRS and/or a PSS and/or an SSS;
ii) performing fine time tracking and acquiring full timing information of the LTM candidate cell;
iii) obtaining time boundaries of time units of a given LTM candidate cell such as a time slot, an OFDM symbol, a subframe, and/or a radio frame; and/or
iv) synchronizing a clock with time boundaries of time units of a given LTM candidate cell such as a time slot, an OFDM symbol, a subframe, and/or a radio frame.

A11. The method of any of the previous embodiments, further comprising:
providing user data; and
forwarding the user data to a host via the transmission to the network node.

### Group B Embodiments

B1. A method performed by a network node for causing a user equipment, UE, to conduct fast Uplink (UL) access on a L1/L2 triggered inter-cell mobility (LTM) candidate cell, the method comprising:
transmitting (1602), from a network node to the UE, an LTM configuration for at least one LTM candidate cell; and
transmitting (1604) a trigger to the UE from the network node.

B1A. The method of embodiment B1, further comprising, after transmitting the trigger, receiving (1606) a UL signal including data from the LTM configuration from the UE during a UL resource occasion (e.g., PRACH occasion) corresponding to the LTM candidate cell, wherein the UL resource occasion occurs during a period of time that is between the UE receiving the trigger and a first synchronization signal (e.g., SSB) of the LTM candidate cell that occurs after the trigger is received by the UE.

B2. The method of embodiment B1 or B1A, wherein the trigger comprises at least one of an RRC message, IE, field, parameter, MAC Control Element (MAC CE) or PDCCH order, wherein the trigger corresponds to one or more of:
a trigger for a time alignment (TA) establishment/update procedure, wherein the trigger is received from the network node in a serving cell (e.g., a PDCCH order from the Primary Cell or Primary SCG cell) instructing the UE to transmit a UL signal (e.g., PRACH preamble) for the TA establishment/update procedure; and/or
a trigger, from the network node in a serving cell (e.g., a MAC CE from the Primary Cell or Primary SCG cell), for an LTM cell switch procedure, wherein the trigger corresponds to an LTM cell switch command that indicates the LTM candidate cell (e.g., LTM configuration ID) the UE is to access.

B3. The method of any of embodiments B1 or B2, wherein the trigger corresponds to a MAC Control Element (MAC CE), a Downlink Control Indication (DCI), Layer 1 (L1) signaling, Layer 2 (L2) signaling, L1/L2 signaling, and indicates at least one of the configured LTM candidate cells (e.g., LTM candidate ID, or LTM configuration ID).

B4. The method of any of embodiments B1 to B3, wherein the UL signal comprises one or more of:
a PRACH preamble transmitted to a PRACH occasion of the LTM candidate cell in an LTM cell switch;
a PRACH preamble transmitted to a PRACH occasion of the LTM candidate cell in a time alignment (TA) establishment/update procedure;
a Sounding Reference Signal (SRS) transmitted to the LTM candidate cell in an TA establishment/update procedure;
a control information (e.g., scheduling request) transmitted on a Physical Uplink Control Channel (PUCCH) of the LTM candidate cell in a LTM cell switch procedure; and/or
UL data (e.g., including as payload a RRC Reconfiguration Complete) transmitted on a Physical Uplink Shared Channel (PUSCH) of the LTM candidate cell in an LTM cell switch procedure.

B5. A method of any of embodiments B1 to B4, wherein the UL resource occasion comprises one or more of:
a PRACH occasion of the LTM candidate cell;
a Sounding Reference Signal resource or resource occasion of the LTM candidate cell that has been configured (e.g., in the RRC configuration of the LTM candidate cell) and/or assigned (e.g., in the LTM cell switch command);
a Physical Uplink Control Channel (PUCCH) resource or resource occasion of the LTM candidate cell that has been configured (e.g., in the RRC configuration of the LTM candidate cell) and/or assigned (e.g., in the LTM cell switch command); and/or
a Physical Uplink Shared Channel (PUSCH) resource or resource occasion of the LTM candidate cell that has been configured (e.g., in the RRC configuration of the LTM candidate cell) and/or assigned (e.g., in the LTM cell switch command).

B6. The method of any of embodiments B1 to B5, wherein the UE transmitting the UL signal to the LTM candidate cell in a configured UL channel resource(s) in a time and frequency before the next synchronization signal (e.g., SSB) of the LTM candidate cell, comprises the UE transmitting the UL signal in the first configured UL channel resource(s) in a time and frequency (e.g., first PRACH occasion) after the reception of the trigger.

B7. The method of any of embodiments B1 to B6, wherein prior to the UE receiving the trigger, the UE receives a configuration from the network node in the serving cell with one or more LTM candidate cell configuration(s) to be applied upon receiving an LTM cell switch command.

B8. The method of any of embodiments B1 to B7, wherein prior to receiving the trigger, the UE receives a configuration for time alignment establishment/update with the LTM candidate cell, wherein the configuration comprises one or more UL related parameters: such as a PRACH preamble configuration, a PRACH occasion(s), a PRACH frequency resource(s), and/or the like.

B9. The method of any of embodiments B1 to B8, wherein the UE is configured with multiple LTM candidate cell(s) and when the UE receives the trigger to transmit a UL signal to an LTM candidate cell which is not in a first subset of the multiple LTM candidate cell(s), transmitting the UL signal to the LTM candidate cell that is not in the first subset, in a configured UL channel resource(s) in a time and frequency after the next synchronization signal (e.g., SSB) of the LTM candidate cell.

B10. The method of any of embodiments B1 to B9, wherein prior to receiving the trigger the UE performs a Downlink (DL) synchronization (or pre-synchronization) with the at least one of the LTM candidate cells, wherein the DL synchronization comprises one or more of:
i) detecting and/or measuring at least one synchronization signal of the LTM candidate cell, wherein the at least one synchronization signal includes an SSB of the LTM candidate cell associated to an SSB index and/or identifier and transmitted in a spatial direction (beam), and/or a CSI-RS and/or a TRS and/or a PSS and/or an SSS;
ii) performing fine time tracking and acquiring full timing information of the LTM candidate cell;
iii) obtaining time boundaries of time units of a given LTM candidate cell such as a time slot, an OFDM symbol, a subframe, and/or a radio frame; and/or
iv) synchronizing a clock with time boundaries of time units of a given LTM candidate cell such as a time slot, an OFDM symbol, a subframe, and/or a radio frame

B11. The method of any of the previous embodiments, further comprising:
obtaining user data; and forwarding the user data to a host or a user equipment.

### Group C Embodiments

C1. A user equipment for conducting fast Uplink (UL) access on a L1/L2 triggered inter-cell mobility (LTM) candidate cell, comprising:
processing circuitry configured to perform any of the steps of any of the Group A embodiments; and
power supply circuitry configured to supply power to the processing circuitry.

C2. A network node for conducting fast Uplink (UL) access on a L1/L2 triggered inter-cell mobility (LTM) candidate cell, the network node comprising:
processing circuitry configured to perform any of the steps of any of the Group B embodiments;
power supply circuitry configured to supply power to the processing circuitry.

C3. A user equipment (UE) for conducting fast Uplink (UL) access on a L1/L2 triggered inter-cell mobility (LTM) candidate cell] the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C4. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

C5. The host of the previous embodiment, wherein:
the processing circuitry of the host is configured to execute a host application that provides the user data; and
the UE comprises processing circuitry configured to execute a client application associated with the host application to receive the transmission of user data from the host.

C6. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

C7. The method of the previous embodiment, further comprising, at the network node, transmitting the user data provided by the host for the UE.

C8. The method of any of the previous 2 embodiments, wherein the user data is provided at the host by executing a host application that interacts with a client application executing on the UE, the client application being associated with the host application.

C9. A communication system configured to provide an over-the-top (OTT) service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

C10. The communication system of the previous embodiment, further comprising: the network node; and/or the UE.

C11. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

C12. The host of the previous 2 embodiments, wherein:
the processing circuitry of the host is configured to execute a host application that receives the user data; and
the host application is configured to interact with a client application executing on the UE, the client application being associated with the host application.

C13. The host of the any of the previous 2 embodiments, wherein the initiating receipt of the user data comprises requesting the user data.

C14. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

C15. The method of the previous embodiment, further comprising at the network node, transmitting the received user data to the host.

C16. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.

C17. The host of the previous embodiment, wherein the cellular network further includes a network node configured to communicate with the UE to transmit the user data to the UE from the host.

C18. The host of the previous 2 embodiments, wherein:
the processing circuitry of the host is configured to execute a host application, thereby providing the user data; and
the host application is configured to interact with a client application executing on the UE, the client application being associated with the host application.

C19. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

C20. The method of the previous embodiment, further comprising:
at the host, executing a host application associated with a client application executing on the UE to receive the user data from the host application.

C21. The method of the previous embodiment, further comprising:
at the host, transmitting input data to the client application executing on the UE, the input data being provided by executing the host application,
wherein the user data is provided by the client application in response to the input data from the host application.

C22. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

C23. The host of the previous embodiment, wherein the cellular network further includes a network node configured to communicate with the UE to transmit the user data from the UE to the host.

C24. The host of the previous 2 embodiments, wherein:
the processing circuitry of the host is configured to execute a host application, thereby providing the user data; and
the host application is configured to interact with a client application executing on the UE, the client application being associated with the host application.

C25. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

C26. The method of the previous embodiment, further comprising:
at the host, executing a host application associated with a client application executing on the UE to receive the user data from the UE.

C27. The method of the previous 2 embodiments, further comprising:
at the host, transmitting input data to the client application executing on the UE, the input data being provided by executing the host application,
wherein the user data is provided by the client application in response to the input data from the host application.

### REFERENCES

[1] 3GPP TS 38.331 v17.1.0, Radio Resource Control (RRC) Protocol Specification
[2] 3GPP TS 38.133, v18.0.0, Requirements for Support of Radio Resource Management
[3] 3GPP TS 38.213, v17.4.0, Physical Layer Procedures for Control

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
6G 6^{th} Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
Radio Network Controller RNC
RNTI Radio Network Temporary Identifier
Radio Resource Control RRC
RRM Radio Resource Management
RS Reference Signal
RSCP Received Signal Code Power
RSRP Reference Symbol Received Power OR
Reference Signal Received Power
RSRQ Reference Signal Received Quality OR
Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

What is claimed is:

1. A method performed by a user equipment, UE, for Uplink, UL, access on a L1/L2 triggered inter-cell mobility, LTM, candidate cell, the method comprising:
receiving, from a network node, a LTM configuration for at least one LTM candidate cell;
receiving a trigger from the network node;
receiving a first synchronization signal from the LTM candidate cell; and
in response to receiving the trigger, transmitting a UL signal to the LTM candidate cell during a UL resource occasion, wherein the UL resource occasion occurs during a period of time that is between receiving the trigger and receiving the first synchronization signal from the LTM candidate cell, wherein the first synchronization signal is received after the trigger is received.

2. The method of claim 1, wherein the trigger comprises at least one of an RRC message, IE, field, parameter, MAC Control Element, MAC CE, or PDCCH order, wherein the trigger corresponds to one or more of:
a trigger for a time alignment, TA, establishment/update procedure, wherein the trigger is received from the network node in a serving cell, instructing the UE to transmit a UL signal for the TA establishment/update procedure; and/or
a trigger, from the network node in a serving cell for an LTM cell switch procedure, wherein the trigger corresponds to an LTM cell switch command that indicates the LTM candidate cell the UE is to access.

3. The method of claim 1, wherein the trigger corresponds to a MAC Control Element, MAC CE, a Downlink Control Information DCI, Layer 1, L1, signaling, Layer 2, L2, signaling, L1/L2 signaling, and indicates at least one of the configured LTM candidate cells.

4. The method of claim 1, wherein the UL signal comprises one or more of:
a Physical Random Access Channel, PRACH, preamble transmitted during a PRACH occasion of the LTM candidate cell in an LTM cell switch;
a PRACH preamble transmitted during a PRACH occasion of the LTM candidate cell in a TA establishment/update procedure;
a Sounding Reference Signal, SRS transmitted to the LTM candidate cell in an TA establishment/update procedure;
a control information transmitted on a Physical Uplink Control Channel, PUCCH of the LTM candidate cell in a LTM cell switch procedure; and/or
UL data transmitted on a Physical Uplink Shared Channel, PUSCH of the LTM candidate cell in an LTM cell switch procedure.

5. The method of claim 1, wherein the UL resource occasion comprises one or more of:
a PRACH occasion of the LTM candidate cell;
a Sounding Reference Signal resource or resource occasion of the LTM candidate cell that has been configured and/or assigned;
a Physical Uplink Control Channel, PUCCH, resource or resource occasion of the LTM candidate cell that has been configured and/or assigned; and/or
a Physical Uplink Shared Channel, PUSCH, resource or resource occasion of the LTM candidate cell that has been configured and/or assigned.

6. The method of claim 1, wherein the UE transmitting the UL signal to the LTM candidate cell in a configured UL channel resource in a time and frequency before the next synchronization signal of the LTM candidate cell, comprises the UE transmitting the UL signal in the first configured UL channel resource in a time and frequency after the reception of the trigger.

7. The method of claim 1, wherein prior to receiving the trigger, the UE receives a configuration from the serving cell with one or more LTM candidate cell configurations to be applied upon receiving an LTM cell switch command.

8. The method of claim 1, wherein prior to receiving the trigger, the UE receives a configuration for time alignment establishment/update with the LTM candidate cell, wherein the configuration comprises one or more UL related parameters: such as a PRACH preamble configuration, a PRACH occasion, a PRACH frequency resource.

9. The method of claim 1, wherein the UE is configured with multiple LTM candidate cells and when the UE receives the trigger to transmit a UL signal to an LTM candidate cell which is not in a first subset of the multiple LTM candidate cells, transmitting the UL signal to the LTM candidate cell that is not in the first subset, in a configured UL channel resource in a time and frequency after the next synchronization signal of the LTM candidate cell.

10. The method of claim 1, wherein prior to receiving the trigger the UE performs a Downlink, DL, synchronization with the at least one of the LTM candidate cells, wherein the DL synchronization comprises one or more of:
i) detecting and/or measuring at least one synchronization signal of the LTM candidate cell, wherein the at least one synchronization signal includes an SSB of the LTM candidate cell associated to an SSB index and/or identifier and transmitted in a spatial direction, and/or a CSI-RS and/or a TRS and/or a PSS and/or an SSS;
ii) performing fine time tracking and acquiring full timing information of the LTM candidate cell;
iii) obtaining time boundaries of time units of a given LTM candidate cell such as a time slot, an OFDM symbol, a subframe, and/or a radio frame; and/or
iv) synchronizing a clock with time boundaries of time units of a given LTM candidate cell such as a time slot, an OFDM symbol, a subframe, and/or a radio frame.

11. The method of claim 1, further comprising:
providing user data; and
forwarding the user data to a host via the transmission to the network node.

12. A method performed by a network node for a user equipment, UE, Uplink, UL, access on a L1/L2 triggered inter-cell mobility, LTM, candidate cell, the method comprising:
transmitting, from the network node to the UE, an LTM configuration for at least one LTM candidate cell; and
transmitting a trigger to the UE from the network node.

13. A user equipment for Uplink (UL) access on a L1/L2 triggered inter-cell mobility, LTM, candidate cell, comprising:
processing circuitry configured to:
receive, from a network node, a LTM configuration for at least one LTM candidate cell;
receive a trigger from the network node;
receive a first synchronization signal from the LTM candidate cell; and
in response to receiving the trigger, transmit a UL signal to the LTM candidate cell during a UL resource occasion, wherein the UL resource occasion occurs during a period of time that is between receiving the trigger and receiving the first synchronization signal from the LTM candidate cell, wherein the first synchronization signal is received after the trigger is received; and
power supply circuitry configured to supply power to the processing circuitry.

14. The user equipment of claim 13, wherein the trigger comprises at least one of an RRC message, IE, field, parameter, MAC Control Element, MAC CE, or PDCCH order, wherein the trigger corresponds to one or more of:
a trigger for a time alignment, TA, establishment/update procedure, wherein the trigger is received from the network node in a serving cell, instructing the UE to transmit a UL signal for the TA establishment/update procedure; and/or
a trigger, from the network node in a serving cell for an LTM cell switch procedure, wherein the trigger corresponds to an LTM cell switch command that indicates the LTM candidate cell the UE is to access.

15. The user equipment of claim 13, wherein the trigger corresponds to a MAC Control Element, MAC CE, a Downlink Control Information DCI, Layer 1, L1, signaling, Layer 2, L2, signaling, L1/L2 signaling, and indicates at least one of the configured LTM candidate cells.

16. The user equipment of claim 13, wherein the UL signal comprises one or more of:
a Physical Random Access Channel, PRACH, preamble transmitted during a PRACH occasion of the LTM candidate cell in an LTM cell switch;
a PRACH preamble transmitted during a PRACH occasion of the LTM candidate cell in a TA establishment/update procedure;
a Sounding Reference Signal, SRS transmitted to the LTM candidate cell in an TA establishment/update procedure;
a control information transmitted on a Physical Uplink Control Channel, PUCCH of the LTM candidate cell in a LTM cell switch procedure; and/or
UL data transmitted on a Physical Uplink Shared Channel, PUSCH of the LTM candidate cell in an LTM cell switch procedure.

17. The user equipment of claim 13, wherein the UL resource occasion comprises one or more of:
a PRACH occasion of the LTM candidate cell;
a Sounding Reference Signal resource or resource occasion of the LTM candidate cell that has been configured and/or assigned;
a Physical Uplink Control Channel, PUCCH, resource or resource occasion of the LTM candidate cell that has been configured and/or assigned; and/or
a Physical Uplink Shared Channel, PUSCH, resource or resource occasion of the LTM candidate cell that has been configured and/or assigned.

18. The user equipment of claim 13, wherein the UE transmitting the UL signal to the LTM candidate cell in a configured UL channel resource in a time and frequency before the next synchronization signal of the LTM candidate cell, comprises the UE transmitting the UL signal in the first configured UL channel resource in a time and frequency after the reception of the trigger.

19. The user equipment of claim 13, wherein prior to receiving the trigger, the UE receives a configuration from the serving cell with one or more LTM candidate cell configurations to be applied upon receiving an LTM cell switch command.

20. The user equipment of claim 13, wherein prior to receiving the trigger, the UE receives a configuration for time alignment establishment/update with the LTM candidate cell, wherein the configuration comprises one or more UL related parameters: such as a PRACH preamble configuration, a PRACH occasion, a PRACH frequency resource.

21. The user equipment of claim 13, wherein the UE is configured with multiple LTM candidate cells and when the UE receives the trigger to transmit a UL signal to an LTM candidate cell which is not in a first subset of the multiple LTM candidate cells, transmitting the UL signal to the LTM candidate cell that is not in the first subset, in a configured UL channel resource in a time and frequency after the next synchronization signal of the LTM candidate cell.

22. The user equipment of claim 13, wherein prior to receiving the trigger the UE performs a Downlink, DL, synchronization with the at least one of the LTM candidate cells, wherein the DL synchronization comprises one or more of:
i) detecting and/or measuring at least one synchronization signal of the LTM candidate cell, wherein the at least one synchronization signal includes an SSB of the LTM candidate cell associated to an SSB index and/or identifier and transmitted in a spatial direction, and/or a CSI-RS and/or a TRS and/or a PSS and/or an SSS;
ii) performing fine time tracking and acquiring full timing information of the LTM candidate cell;
iii) obtaining time boundaries of time units of a given LTM candidate cell such as a time slot, an OFDM symbol, a subframe, and/or a radio frame; and/or
iv) synchronizing a clock with time boundaries of time units of a given LTM candidate cell such as a time slot, an OFDM symbol, a subframe, and/or a radio frame.

23. The user equipment of claim 13, further comprising:
providing user data; and
forwarding the user data to a host via the transmission to the network node.

24. A network node for Uplink (UL) access on a L1/L2 triggered inter-cell mobility, LTM, candidate cell, the network node comprising:
processing circuitry configured to transmit, from the network node to the UE, an LTM configuration for at least one LTM candidate cell, and transmit a trigger to the UE from the network node; and
power supply circuitry configured to supply power to the processing circuitry.
